(19) United States
(12) Patent Application Publication
(10) Pub. No.: US 2025/0310134 A1
(43) Pub. Date: Oct. 2, 2025

(54) DATA COLLECTION WITH CUSTOMIZABLE BLOCKCHAIN PROCESSING

(71) Applicant: InterDigital Patent Holdings, Inc., Wilmington, DE (US)

(72) Inventors: Xu Li, Plainsboro, NJ (US); Chonggang Wang, Princeton, NJ (US); Efat Fathalla, Lexington, VA (US); Robert Gazda, Spring City, PA (US); Debashish Purkayastha, Eagleville, PA (US); Michael Starsinic, Newtown, PA (US)

(73) Assignee: InterDigital Patent Holdings, Inc., Wilmington, DE (US)

(21) Appl. No.: 18/864,194

(22) PCT Filed: May 9, 2023
(86) PCT No.: PCT/US2023/021469

§ 371 Date: Nov. 8, 2024

Related U.S. Application Data
(60) Provisional application No. 63/339,801, filed on May 9, 2022.

(51) Int. Cl. H04L 9/00

(52) U.S. Cl. CPC H04L 9/50; H04L 2209/80

(57) ABSTRACT

Systems and methods are described herein for data collection customizable blockchain processing. An apparatus may be configured to set up and configure a customizable blockchain, for example, for a data collection request. The apparatus may receive a data collection request (DCR) from a data consuming (DC) device (e.g., associated with an application). The apparatus may send an identification request (e.g., data provider identification request) to one or more devices (e.g., data providers). The apparatus may receive an indication indicating qualified devices (e.g., qualified data providers). The apparatus may send a blockchain request (e.g., custom blockchain request) to a blockchain system. The blockchain request may indicate the data collection request (e.g., parameters associated with the DCR) and the qualified devices. The apparatus may receive configuration information from the blockchain system, for example, that may be an operating guideline.

### CROSS-REFERENCE TO RELATED APPLICATIONS

The application claims the benefit of U.S. Provisional Application 63/339,801, filed May 9, 2022, the contents of which are incorporated by reference in their entirety herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for data collection customizable blockchain processing. An apparatus may be configured to set up and configure a customizable blockchain, for example, for a data collection request.

The apparatus may receive a data collection request (DCR) from a data consuming (DC) device (e.g., associated with an application). The apparatus may send an identification request (e.g., data provider identification request) to one or more devices (e.g., data providers). The apparatus may receive an indication indicating qualified devices (e.g., qualified data providers). The apparatus may send a blockchain request (e.g., custom blockchain request) to a blockchain system. The blockchain request may be a blockchain transaction. The blockchain request may indicate the data collection request (e.g., parameters associated with the DCR) and the qualified devices. The apparatus may receive configuration information from the blockchain system, for example, that may be an operating guideline. The configuration information may be a blockchain transaction. The apparatus may send the confirmation information to the qualified devices, for example, so the qualified devices may (e.g., may know how to) interact with the blockchain system. The apparatus may confirm with the qualified devices regarding when to start generating/submitting data, for example, to the blockchain system. The apparatus may send a confirmation to the data consuming device indicating that the data collection request has been processed.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example workflow of a blockchain system.

FIG. 3 illustrates an example system architecture that may be used with the embodiment described herein to provide and/or process a blockchain.

FIG. 4 illustrates an example use case of personal webcasting.

FIG. 5 illustrates an example workflow that may be used to provide data collection for artificial intelligence (AI) and/or machine learning (ML) model training.

FIG. 6 illustrates an example architecture of the Data Collection Enabler (DCE).

FIG. 7 illustrates an example procedure that may be used for setting up and/or configuring a customizable blockchain for a DCR.

FIG. 8 shows an example of DCR (e.g., DCR-1) collecting real-time locations of a list of one or more targeted WTRUs.

FIG. 9 shows a DCR (e.g., DCR-2) that may be used for collecting historical location/mobility data.

FIG. 10 illustrates an example of how CDB-1 and/or ADB-1 may be created for serving DCR-1 using virtualized blockchain technology.

FIG. 11 illustrates an example of an operating guideline for serving DCR-1

FIG. 12 illustrates an example procedure that may be used as a data collection process via a DCE.

FIG. 13 illustrates another example procedure that may be used as a data collection process via a DCE.

FIG. 14 illustrates an example of a data submission process with DP coordination (e.g., Approach-1: DP Coordination via DCE).

FIG. 15 illustrates an example data submission process with DP coordination (e.g., Approach-2: direct coordination between DPs).

FIG. 16 illustrates an example of data collection with a CP (e.g., a single CIP).

FIG. 17 illustrates an example of data collection with a CIP group.

FIG. 18 illustrates an example of data collection with proactive wireless resource control

FIG. 19 illustrates an example procedure where the DCE and blockchain system may be external to a system.

FIG. 20 illustrates an example procedure where a blockchain system may be used.

FIG. 21 illustrates an example of a procedure that may be associated with using a distributed storage system.

FIG. 22 illustrates an example service flow procedure for a possible customized blockchain setup and configuration procedure.

FIG. 23 illustrates an example procedure where the DCE and blockchain may be network functions (NFs).

FIG. 24 illustrates an example procedure that may use a blockchain system in a layer, such as the SA6 service enablement layer.

FIG. 25 illustrates an example procedure using one or more distributed storage system(s).

FIG. 26 illustrates an example permissioned distributed ledger (PDL) procedure.

FIG. 27 illustrates an example PDL procedure.

FIG. 28 shows another example PDL procedure.

FIG. 29 shows another example PDL procedure.

### DETAILED DESCRIPTION

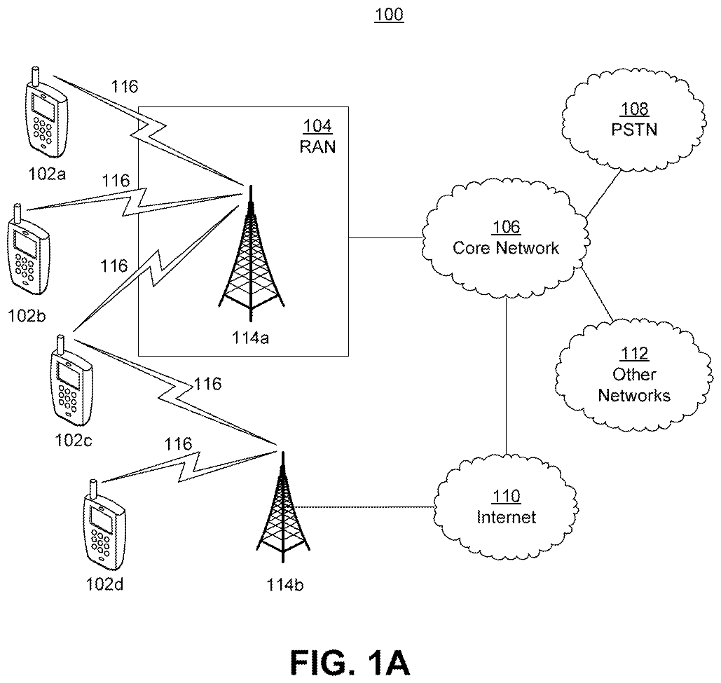

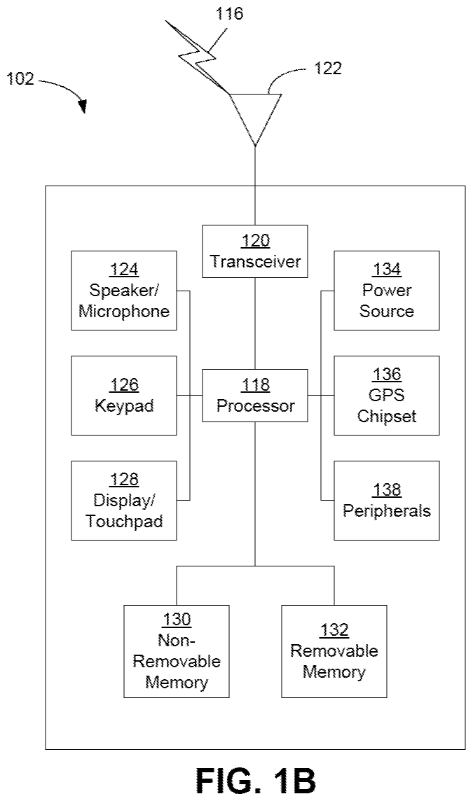

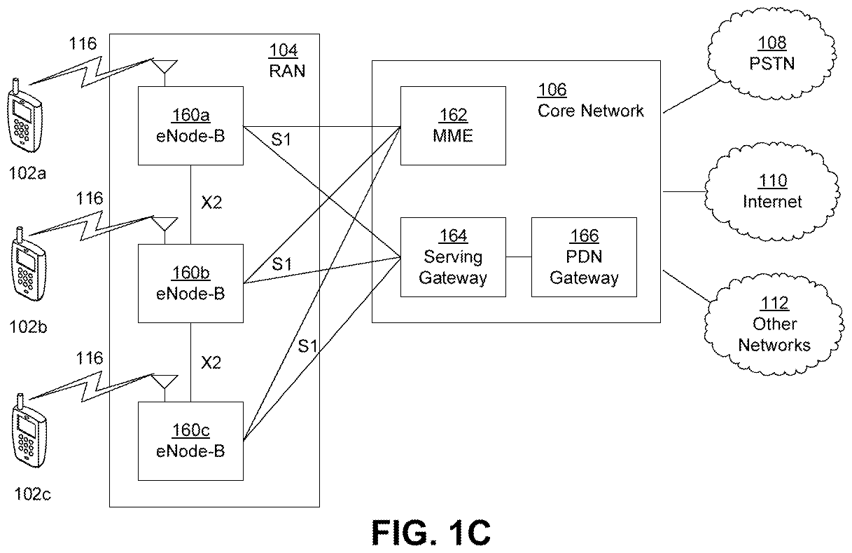

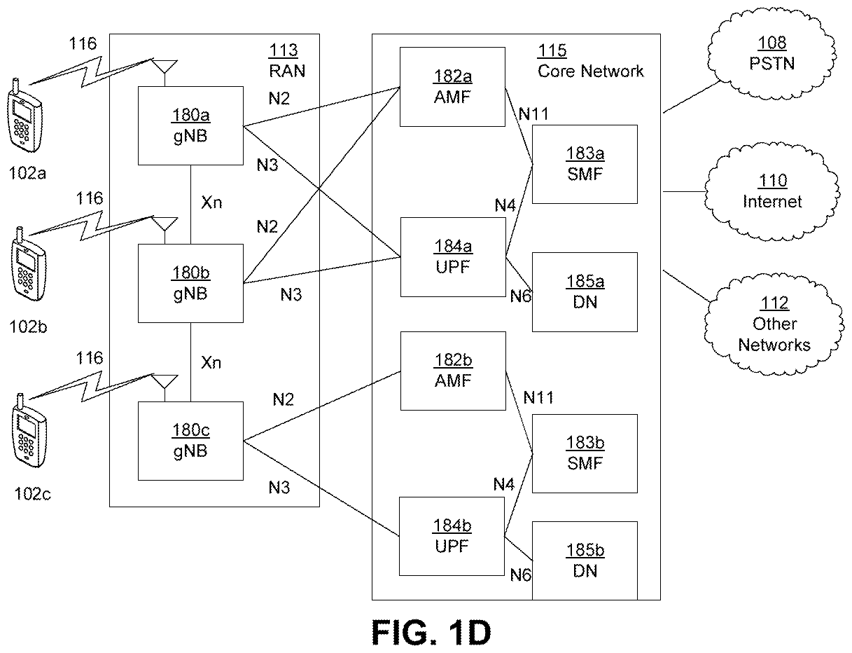

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN). and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “adhoc” mode of communication.

When using the 802. 11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802. 11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 02b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, one or more emulation devices may perform one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are described herein for data collection customizable blockchain processing. For example, an apparatus may be configured to set up and configure a customizable blockchain for a data collection request.

The apparatus may receive a data collection request from a data consuming (DC) device. The apparatus may send an identification request to one or more devices, such as data providers. The apparatus may receive an indication indicating qualified devices, such as qualified data providers. The apparatus may send a blockchain request to a blockchain system. The blockchain request may be a blockchain transaction. The blockchain request may indicate the data collection request and the qualified devices. The apparatus may receive configuration information from the blockchain system, for example, which may be an operating guideline. The configuration information may be a blockchain transaction. For example, the apparatus may send the confirmation information to the qualified devices, so the qualified devices may interact with the blockchain system. The apparatus may confirm with the qualified devices regarding when to start generating/submitting data, for example, to the blockchain system. The apparatus may send a confirmation to the data consuming device indicating that the data collection request has been processed.

Blockchain technology may be used. Blockchain technology may be a technology that jointly leverages and builds on top of one or more of the following techniques: cryptography, hashing, Merkle tree, distributed ledgers, Peer-to-Peer (P2P) networking, consensus protocols, and/or the like. Blockchain technology may (e.g., innovatively) integrate the techniques together to enable a system that may provide advanced features, for example, such as decentralization, immutability, transparency, and security. A blockchain system may be referred to as the system using blockchain technology. Blockchain Nodes (BCN) may be connected (e.g., via P2P links) and form a mesh P2P network, for example, over which transactions and blocks may be broadcast among (e.g., all) blockchain nodes. A blockchain node may connect to multiple other blockchain nodes as its neighbors or neighboring blockchain nodes. Applications using and/or supported by a blockchain system may be referred to as blockchain applications. A blockchain system may be underpinned by underlying blockchain networks, for example, which may be composed of (e.g., many) participating blockchain nodes. A (e.g., each) blockchain node may host one or more distributed blockchains (e.g., a form of distributed ledgers) and may participate in the blockchain system. For example, blockchain nodes may broadcast blockchain transactions and blocks among each other using peer-to-peer networking. Blockchain nodes may perform consensus protocols with each other to reach distributed trust (e.g., without relying on a centralized party). A blockchain transaction may include one or more of the following: a real-world transaction, a digital record of physical assets, a digital record of a physical event, a digital record of any action in an information system, a digital payment, and/or a digital smart contract. A block may group multiple blockchain transactions together. A blockchain may be a data structure to chain a growing number of blocks.

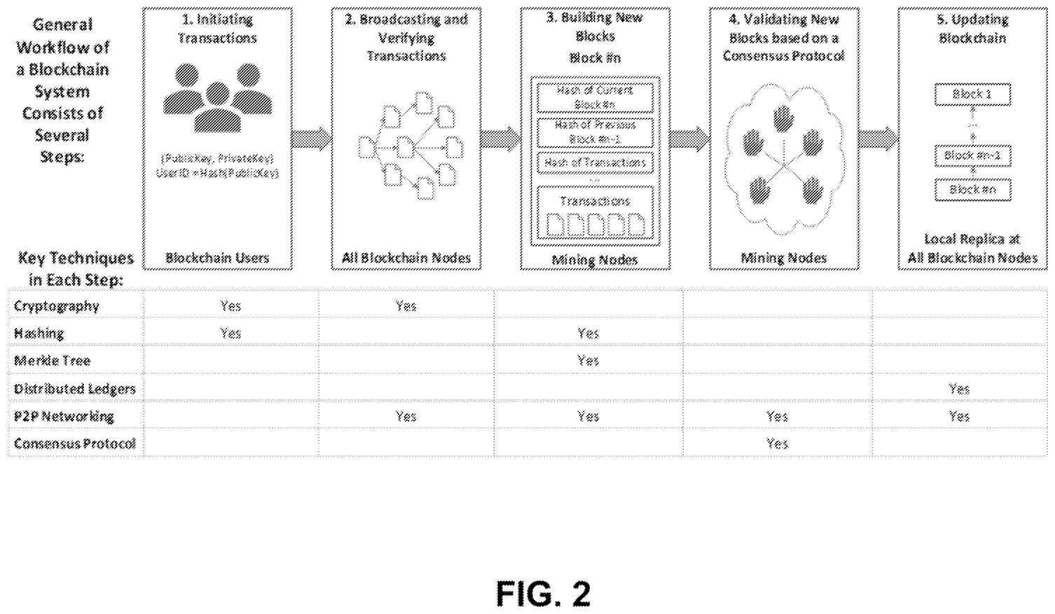

FIG. 2 illustrates an example workflow of a blockchain system. FIG. 2 shows one or more techniques that may be involved in a blockchain system.

As shown in FIG. 2, a transaction may be initiated. For initiating a transaction, a (e.g., each) participating user may generate one or more (e.g., new) transactions independently. A (e.g., each) user may have a user or account identifier (e.g., a hash of the user's public key). A (e.g., each) transaction (e.g., new transaction) may be signed, for example, using the user's private key. After a (e.g., new) transaction may be generated, the user may send it to the blockchain network.

As shown in FIG. 2, broadcasting and verifying transactions may be performed. A (e.g., new) transaction may be received by one or more blockchain nodes, for example, which may verify its integrity using the user's public key (e.g., which may be included in the transaction). After the verification and if the (e.g., new) transaction may be valid, it may be relayed and broadcast within the blockchain network. Blockchain nodes may receive and have a copy of newly generated and valid transactions.

As shown in FIG. 2, a procedure may be performed, which may include building (e.g., new) blocks. Blockchain nodes (e.g., referred to as Mining Nodes or Full Nodes) may (e.g., start to) group (e.g., many) generated (e.g., newly generated) and pending transactions together, for example, to generate a block (e.g., a new block). The block may include a block header and a block body. The block header may include a hash of the current block, a hash of the previously-confirmed block, and/or a hash of (e.g., all) included transactions (e.g., Merkle tree). The block header may contain additional information (e.g., the information may depend on the consensus protocol). The block body may contain the content of (e.g., all) included transactions. A (e.g., each) mining node may create (e.g., independently attempt to create) a (e.g., new) block.

As shown in FIG. 2, a procedure may be performed, which may include validating (e.g., new) blocks, for example, based on a consensus protocol. Mining nodes may create (e.g., independently attempt to create) a (e.g., new) block. The mining nodes may run a (e.g., the same) consensus protocol (e.g., Proof-of-Work in the Bitcoin system) and reach an agreement on who (e.g., a winner) may (e.g., is allowed to) insert a block to the existing blockchain. The winner of the consensus protocol may send its (e.g., newly) generated block to the blockchain network. This (e.g., new) block may be broadcasted and may let (e.g., all) mining nodes receive it and verify it.

As shown in FIG. 2, one or more procedures may be performed, which may include updating the blockchain. After the generated block, which may be newly generated, may be verified, the block may be appended to the existing blockchain. For example, the block may be successfully appended to the existing blockchain because it contains a hash of the previous block, which may be the last block of the previous blockchain.

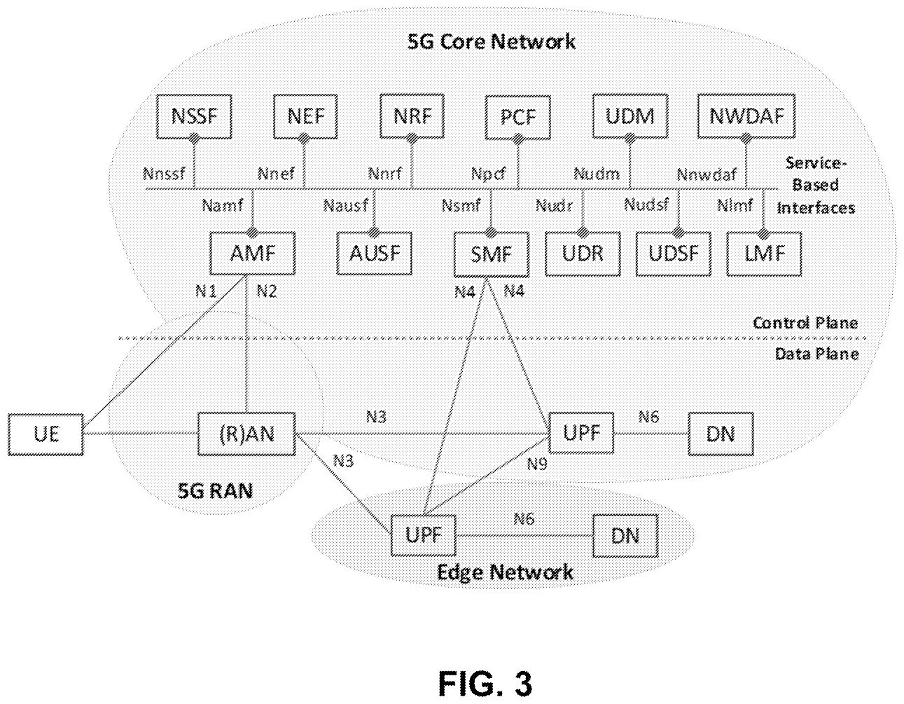

A system architecture, which may be used to provide and/or process a blockchain, may be provided and/or used. For example, FIG. 3 illustrates a system architecture that may be used with the embodiment described herein to provide and/or process a blockchain.

A (e.g., 5G) system architecture may include User Equipment (UE) (e.g., WTRU(s), Radio Access Network (RAN), and/or a Core Network. A design principle for a (e.g., 5G) system architecture may be service-centric or service-based. As shown in FIG. 3, a (e.g., 5G) Core Network may include (e.g., a variety of) network functions, for example, which may work together to fulfill and provide needed services (e.g., to RAN, a WTRU, and an Application Server/Service Provider). A network function may access another network function in request/response mode or subscription/notification mode. Before multiple (e.g., two) network functions interact with each other, they may (e.g., first) register (e.g., need to register) with a Network Repository Function (NRF), for example, so that they may discover each other from NRF. Among these network functions, the Access and Mobility Management Function (AMF) may be dedicated to managing a WTRU's access to a (e.g., 5G) system and its mobility. A Session Management Function (SMF) may establish (e.g., be responsible for establishing) sessions between a WTRU and a (e.g., 5G) core network. An Authentication Server Function (AUSF) may take charge of WTRU authentication. A Policy Control Function (PCF) may provide policy rules for other control plane network functions and WTRU(s). The PCF may assign an identifier for a (e.g., each) created policy rule, for example, which other control plane network functions and WTRU(s) may use to refer to the corresponding policy rule. A User Plane Function (UPF) may be the (e.g., only) function for the user plane, for example, which may enable providing functionality to monitor, manage, control, and redirect user plane traffic flows (e.g., such as between a WTRU and an application server or data network). A Network Exposure Function (NEF) may enable exploring control plane functions to entities (e.g., network applications outside the 5G system and not in the same trusted domain). A core network (e.g., 5G core network) may provide data storage and analytics services through functions (e.g., Unified Data Management (UDM), Unified Data Repository (UDR), Unstructured Data Storage Function (UDSF) and Network Data Analytics Function (NWDAF). Network slicing may be a (e.g., critical) feature in a (e.g., 5G) system, for example, which may be facilitated by a Network Slice Selection Function (NSSF). The network functions may be defined as separate logical entities. Some example scenarios may use (e.g., require) multiple network functions. For example, WTRU mobility may use an AMF, an AUSF, and an SMF. For a type of network function, multiple instances may be instantiated, and NRF may maintain the information of the (e.g., each) instantiated network function instance. With edge computing, (e.g., some) network functions (e.g., in 5G Core Network, for example, such as UPF and NEF) may be deployed and reside in an edge network that is much nearer to and potentially co-located with a RAN.

Vertical applications may be provided. Edge computing capabilities may be adopted.

Service Enabler Architecture Layer (SEAL) services may be (re) used across vertical applications. SEAL may specify northbound APIs to enable flexible integration with vertical applications. Features of SEAL services may include a common core service set, for example, such as group management, configuration management, location management, identity/key management, and network resource management. SEAL services may be supported (e.g., both) in on-network and/or of-network (e.g., WTRU-WTRU communication) deployments. For example, if (e.g., when) a SEAL server may be deployed at the edge, a SEAL client on a WTRU may send its requests to the SEAL server (e.g., for accessing certain services provided at the edge).

EDGEAPP may include an application architecture for enabling edge applications over networks. Architecture requirements may be identified (e.g., discovery of edge services, authentication of the clients). An application layer functional model and corresponding applications may be supported, for example, to enable the deployment of applications on the edge of networks (e.g., with minimal impact to edge-based applications on the WTRU).

The basis for the operation of permissioned distributed ledgers (e.g., with the aim of creating an open ecosystem of industrial applications for deployment by different sectors), which may facilitate the application of these applications technology. Infrastructure and operational aspects may be addressed. There may be open and known operational mechanisms for validating participant nodes, node management, smart contract lifecycle management, ledger security and operation. These mechanisms may be defined and used to establish trusted links between different ledgers.

PDL reference architecture may include one or more of the following layers: PDL Applications (e.g., applications using PDL technology); a PDL Platform Services Layer (e.g., which may support various types of applications), for example, which may provide useful services for applications and as a result, an application may leverage services from the PDL Service Layer (e.g., which may reduce the application's complexity, accelerate application development and deployment and increase interoperability); and/or a DLT Layer (e.g., an implementation of a PDL using a specific DLT type).

Blockchain technology may be used for distributed data collection. For example, data may be generated at the edge of the network (e.g., more at the network's edge than in the cloud). WTRUs may become more and more powerful and may support many heavyweight local computing and communication tasks, for example, such as personal/live webcast services. For example, individuals may use their own smartphones to host a personal webcast (e.g., using the TikTok app). Those individuals may be network anchors/celebrities and may have millions of fans. With the rise of edge computing, the network architecture may gradually evolve from a centralized network service architecture to a (e.g., more) distributed architecture.

Considering data storage and data exchange scenario as an example, a large amount of data may be generated at the edge of the network (e.g., because the data providers may be located at the edge of the network, such as a large number of IoT terminals or mobile phones). The data may be (e.g., directly) digested/consumed at the edge side (e.g., a large number of data consumers are various distributed applications/Apps hosted on mobile phones, etc.). A mobile phone may generate (e.g., a large amount of) application-level data (e.g., such as video stream data in a live webcast, etc.), and may generate (e.g., a lot of) communication-related data, for example, in the lower layer (e.g., if/when communicating with the nearby base stations, such as, for example, a gNB in a cellular network). Context data examples (e.g., real-time wireless context data) may include one or more of the following: the phone's real-time location, connectivity status, current signal strength, reachability status, etc. The wireless context data may provide rich context information, for example, providing (e.g., useful) input for optimization and decision-making support of upper-layer applications.

In examples associated with computer operating systems, Inter-Process Communication (IPC) may be used to support data exchange between a data-provider process and a data-consumer process. In the IPC scheme, multiple (e.g., two) approaches may be used. Direct message passing may be used, for example, in which process A may directly interact with process B by sending messages to exchange data. Shared memory may be used, for example, to achieve data exchange by using a common address space in the memory. The approaches may have similar usages in scenarios other than the traditional computer operating systems. For example (e.g., for the IPC method), the core network of the current system may define the NEF network function (NF), and external entities may leverage system capabilities or collect data (e.g., such as the current location of a given WTRU) by interacting with the NEF. The data exposed by NEF may provide (e.g., valuable) information for (e.g., external) entities (e.g., such as upper-layer applications). From this perspective, this example may be regarded as a generalized message-passing scheme. For the shared memory approach (e.g., with respect to wireless data), an implementation may be that the data collected from the wireless system may be uploaded to the cloud, and (e.g., all) external entities (e.g., as data consumers) may refrain from interacting (e.g., do not need to interact directly) with the system (e.g., which may be an advantage for the case where those data consumers may not have the ability to interact with the system directly). The external entities may (e.g., only need to) access a shared cloud storage space to obtain the desired/collected data. Cloud storage may be used as a (e.g., generalized) shared memory. If extending the shared memory concept and examining it from a web architecture perspective, the shared database approach may be used for enabling data sharing. For example, (e.g., most of the current) web applications may no longer use the traditional monolithic architecture (e.g., in which all the functionalities are implemented in a single unified unit). Web applications (e.g., many current large-scale web applications) may adopt a microservices-based architecture, for example, in which related functionalities may be realized by individual/smaller service units. Accordingly, the database may enable information exchange for those microservices. For example, a billing and payment service may create a billing record in a billing database while a product delivery service may check whether a billing record has the status of “payment completed” (e.g., so that the product delivery service may start to arrange the logistics companies (e.g., such as UPS) for product delivery).

Applications (e.g., most applications) may operate at the edge of the network and data generation and digestion may occur at the edge of the network (e.g. as described herein). In the previous example, context data about a mobile phone may be collected from the mobile phone terminal itself and/or from a near-by base station serving this phone, etc. Apps (e.g., a large number of Apps, such as wireless Data Consumers, or DCs) may be deployed on mobile phones, for example, so the collected context data may be directly digested at the network edge. Blockchain may enable (e.g., be a preferred solution as) an intermediate storage medium to store the collected data from Data Providers (DPs), for example, which may have one or more of the following advantages: supporting data sharing between untrusted entities (DPs/DCs), providing data tamper-proof support (e.g., so that data may not be tampered during the collection process), supporting traceability (e.g., hard-record data circulation history), supporting native incentive mechanism with rewards allocation, etc. The data collection via blockchain system may be conducted with (e.g., minimum) access delays, for example, because data (e.g., especially for the real-time context data) may be short-lived.

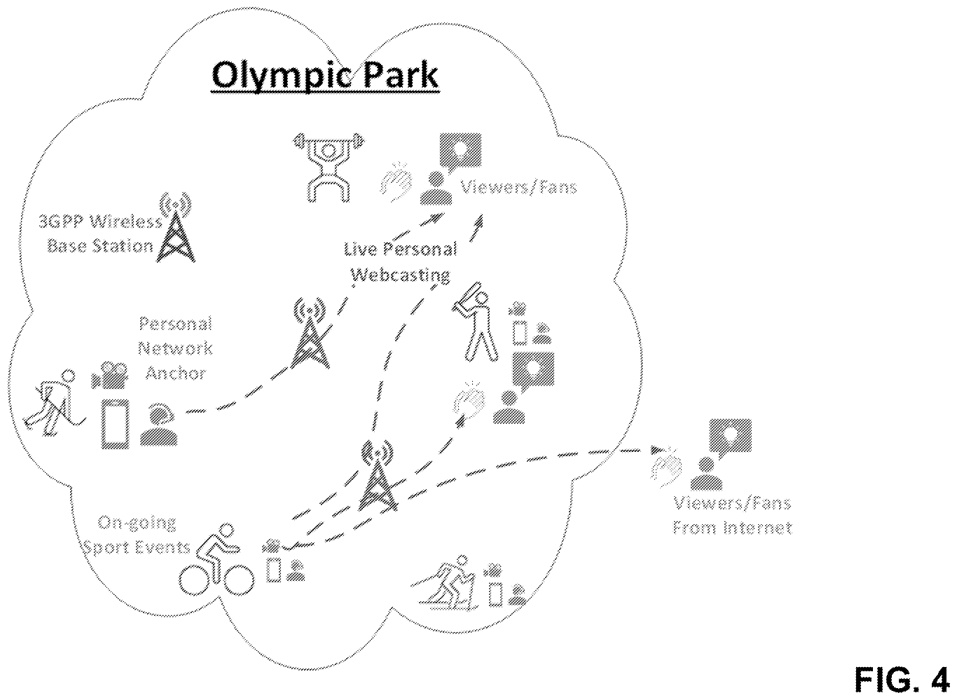

FIG. 4 illustrates an example use case of personal webcasting. In examples, a use case may include personal webcasting (e.g., in a park, in an Olympic Park). For example, FIG. 4 may illustrate an example use case of personal webcasting in an Olympic park.

As shown in FIG. 4, there may be visitors/spectators from all over the world in the park. At the same time, various sports competitions/events may be held throughout the park. Personal webcasters may be present in the park. In this application, the personal network anchors may broadcast live streaming (e.g., for singing, playing, selling things, etc.), and at the same time, a large number of his/her fans (e.g., as viewers) may interact with network anchors. In particular, this business model may have upended the traditional media industry. For example, the providers of media data may no longer be considered to be traditional TV stations or large video-on-demand websites (e.g., such as Hulu, Netflix, etc.). Individuals may become personal network anchors and may generate income through their mobile phones. For example, the market size of China's online performance industry may be large (e.g., 30 billion US dollars).

It may be expected that in the Olympic park, there may be many individual network anchors who may broadcast live events at the game sites. Personal live broadcast (e.g., unlike traditional TV live broadcasts which may use professorial equipment, high-speed connection, etc.) in the Olympic park may be associated with one or more of the following characteristics: network anchors may use (e.g., rely on) their own personal mobile phones, which may not be professional equipment, for example, where the mobile phone may use (e.g., need to use) wireless communication via a cellular access network (e.g., normally based on a personal subscription plan), especially for some mobile/outdoor sports events, such as marathons, golf, etc.; the mobile phones/devices may be dense (e.g., in the Olympic park) that the anchors' mobile phones may not be able to obtain (e.g., sufficient) wireless bandwidth, such that the live broadcast may not be performed smoothly (e.g., especially if an anchor's WTRU does not have a VIP service subscription to the wireless operator); for video viewers (e.g., the fans of those network anchors), they may be visitors who are also in the Olympic Park or may be remote video viewers accessing the content from the Internet; etc.

In examples, if (e.g., when) video viewers search for a network anchor, they may care about the content and location of the network anchor (e.g., whether an individual anchor may be in the best viewing spot for a certain event) and whether the anchor has good video streaming quality (e.g., especially throughout important events, such as swimming finals), which may be evaluated via certain real-time wireless context data collected from the wireless system, such as wireless signal and data rates of the network anchor, etc. For example, a video viewer may have the following query to find qualified anchors: I want to find a network anchor who may be broadcasting the final on a tennis court, close to player Amy's side. For content quality and stability, users may expect high-quality (HD) video streaming and expect the video content may be provided in a stable way (e.g., throughout the swimming final). Such user requirements may imply that the desired network anchor may have continuous/excellent wireless cellular connection status and may be expected to be allocated with high-speed bandwidth. It may be seen that for processing this user query, the wireless context data of the network anchor may be (e.g., very) important for answering this query. The data may be collected from the cellular network that the network anchor may be using (e.g., as the provider of wireless data). The wireless data may be collected and provided to the upper-layer live webcast application software (e.g., as the wireless data consumers) to support the network anchor search/filtering or other performance optimization operations.

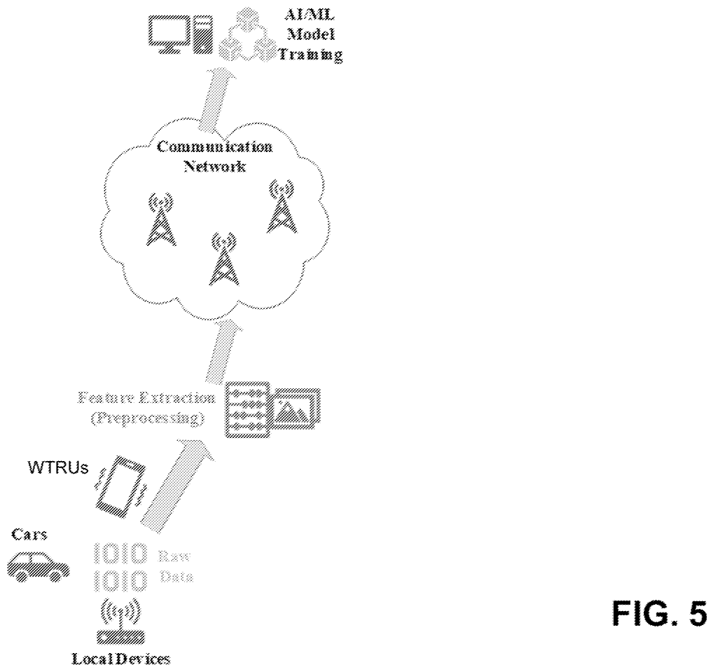

In examples, a use case may include data collection for AI/ML model training. FIG. 5 illustrates an example workflow that may be used to provide data collection for artificial intelligence (AI) and/or machine learning (ML) model training. For example, FIG. 5 may illustrate an example use case of data collection for AI/ML model training.

Data (e.g., raw data) for Al/ML model training may be generated by various terminals, for example, such as WTRUs/devices, etc. The data may be collected (e.g., need to be collected) and sent to an Al/ML server for Al model training purposes. Depending on the applications, various data (e.g., raw data) may be generated (e.g., which may include images). For example, the data (e.g., raw data) may not be immediately useful for AI/ML training because pre-processing may be conducted. For example, feature extraction may be used (e.g., to extract useful information from the data, such as raw data), and (e.g., only) the extracted feature data may be sent to the AI/ML server for training. Feature extraction may save the communication cost for the data transfer. Data collection and data processing are described herein in a general sense, e.g., the data collection and data processing as described herein may include other (e.g., any) types of data preprocessing (e.g., and may be not just limited to model feature extraction). For example, data (e.g., raw data) preprocessing may include (e.g., but is not limited to) information extraction, format transformation, blockchain transaction creation, secure data encoding, numerical data aggregation, etc.

In view of the various advantages of using blockchain (e.g., as described herein, for example, such as to support data exchange between untrusted entities, supporting immutability, supporting native incentivization, etc.), blockchain may be used as a distributed storage medium to support data collection.

Using blockchain for data collection may create problems (e.g., some new problems), and challenges, for example, such as the following.

An issue in using blockchain for data collection may be that the internal system of the blockchain may lack flexibility and adaptability. It may not be able to perform customizable or differentiated blockchain processing, for example, according to different application data types and requirements.

For example (e.g., in the Olympic Park scenario as described herein), a viewer may be watching a golf final from multiple (e.g., three) different network anchors. The viewer may need to know the current positions of different anchors (e.g., in real-time) and switch (e.g., in time). For example, if (e.g., when) anchor 1 may be broadcasting the game of player A on the 12th hole, the viewer may find that based on anchor 2's (e.g., real-time) location information, anchor 2 may be walking approaching another player B's game on the 14th hole. If (e.g., because) the viewer cares more about player B, the viewer may switch to the live channel of anchor 2 (e.g., immediately). The (e.g., upper-layer live) broadcast application and the viewer may (e.g., need to) obtain the current context data of different network anchors (e.g., in real-time). However, a potential issue may be that because the data may be shared through the blockchain, a delay may exist (e.g., there may be delays caused by blockchain processing), for example, the data on-chaining process (e.g., conducting certain consensus protocol). The time cost caused by the consensus protocol may not be negligible, and the DCs (e.g., upper-layer application) may want to consume/use the location information after the information is recorded in the blockchain through the data on-chain process. In some examples, an anchor may post an announcement (e.g., live announcement) advertisement to the blockchain system (e.g., at 10:00 a.m.), which may tell potential viewers that she would do the live streaming for the 200-meter backstroke final at the best viewing position in the swimming pool at 6:00 p.m. today, and her camera may mainly be aimed at a very popular player. For such a piece of ads-related information, a certain on-chaining delay may be (e.g., completely) tolerable (e.g., half-hour). In use cases (e.g., in the Olympic Park and other use cases), different data types may have different on-chaining delay limits/requirements. For example, (e.g., real-time) wireless data may (e.g., need to be) shared with data consumers (e.g., as soon as possible), for example, and therefore it may need a minimum on-chaining delay. In some examples, the data may have a looser delay requirement.

The (e.g., general) blockchain processing may include a number of phases, for example, including transaction creation, transaction verification, block building/assembly, blockchain validation (e.g., via consensus protocol), and/or block appending. The blockchain validation for reaching consensus may be a (e.g., the most) time-consuming processing phase, for example, if (e.g., when) using a PoW consensus protocol. An issue may be that (e.g., most of) the current blockchain systems adopt an operation mechanism (e.g., a single operation mechanism) and may refrain from accounting for (e.g., do not take into account) the delay requirements of various types of application data. For example, the existing blockchain systems (e.g., no matter whether the data may be urgent or not) may be able to (e.g., only) use the same data on-chaining process (e.g., the same consensuses protocol). Existing blockchain systems may be unable to (e.g., may not) respond to various data on-chaining delay requirements with adaptive blockchain processing. Miners in existing blockchain systems may prioritize some transactions marked with high transaction fees (e.g., even so, the data on-chaining delay may be uncontrollable (e.g., especially when using PoW protocol). It may not be known (e.g., almost impossible to know) in advance which miner may win in the next round. Implementations may enable optimized/customized blockchain processing, for example, to meet the different on-chaining delay requirements.

In blockchain technology, there may be a lack of (e.g., efficient) coordination between the blockchain system and its users outside the blockchain system. In examples (e.g., with respect to the Olympic Park example as described herein), the current context data from the tennis hall may (e.g., need to) be collected (e.g., such as wireless signal strength, temperature, humidity, air quality, etc.). Suppose there are three network anchors currently broadcasting at the tennis hall, and they are seated close together. If an (e.g., one or more three) anchor's smart phone may collect the information, they may submit their respective sensory readings to the blockchain system. A problem may be that the data are functionally duplicated (e.g., because they were sampled at similar times/locations), although they may be treated as different data records (e.g., contained in different blockchain transactions) in the blockchain system. As a result, the redundancy of the blockchain system may be increased, and the workload of the blockchain system may be increased. Consequently, the data on-chaining delay of other data may be increased.

In blockchain technology, the collected data (e.g., raw data) may not be preprocessed in an effective way. For example, blockchain technology may be able to get data; however, the data may not be preprocessed in an effective way.

In examples (e.g., with respect to the data collection for AI/ML training use case), a requirement may include that the collected data (e.g., raw data) from various terminals (e.g., as data providers or DP) shall be preprocessed (e.g., conducting feature extraction as well as one or more other types of operations). It may be a difficult (e.g., not easy) task to conduct the preprocessing, for example, if (e.g., when) considering in a fully distributed scenario where there may not be a central controller for AI/ML training coordination or control. The participants may not have affiliation with each other and may not trust each other. It may not be possible to deploy a feature extractor, for example, to conduct the desired feature extraction operation.

It may not be possible to deploy a feature extractor. For example, the AI/ML training server/controller may not have the capability to design a data pre-processor module. For example, the AI/ML model training controller may not have the capability/knowledge to understand the data (e.g., raw data), such as the low-level wireless communication channel metadata. A certain 3rd-party may be involved in conducting the desired feature extraction.

It may not be possible to deploy a feature extractor. For example, even if the AI/ML training server/controller has its own feature extraction module in hand, it may not know where to deploy the module. For example, it may not know which entities (e.g., various terminals, devices, WTRUs at the edge) may provide a computing host for running feature extraction module.

It may not be possible to deploy a feature extractor. For example, the DPs (e.g., generating the data (e.g., raw data) may be resource-constrained devices or have limited capabilities. It may not be feasible to let those devices directly conduct the feature extraction by themselves. It may also be that the AI/ML training controller may not have any control over deploying the desired feature extraction module on the DPs. For example, they may not be trusted by a other (e.g., affiliated with different organizations).

Collected data (e.g., raw data) may not be preprocessed in an effective way. Conducting data preprocessing in a fully distributed scenario by leveraging potential capabilities (e.g., not a (e.g., only) the computing capacity, but also certain application-specific data preprocessing capabilities) of untrusted entities (e.g., those staying close to the DPs) may be a (e.g., major) issue.

In blockchain technology, the wireless resources of DPs may not be (e.g., unable to be) adjusted for a better data collection process.

DPs may often be mobile terminals and may (e.g., need to) use the various wireless medium for communication. For example, various WTRUs/devices/terminals may be using a cellular network for communication, in which those entities connect to the base stations, such as a gNB. The data collection may (e.g., need to) utilize the wireless data connection capabilities of DPs. If the data connections of DPs become worse and affect the data collection, the data collection process may have to be adjusted accordingly, such as to slow down the data collection or to pause the data collection for some time, in order to cater to the downgraded connectivity. The data collection process may not have (e.g., any) control over the wireless resources allocated to the DPs and may (e.g., only) reactively conduct data collection adjustments. Some DPs may become unavailable from time to time. An efficient DP re-selection method may be used, for example, in order to find alternative DPs, such as one temperature sensing device that may replace another one if they are in the same area and that may provide the same type or equivalent data. In examples, the DP may not be replaced by others, for example, if such a DP, which may be defined as an irreplaceable DP, may be a specific data provider target, such as a heartbeat monitoring sensor mounted on a specific patient A. If that may be the case, DP re-selection may not be feasible anymore. As a result, the data collected from such irreplaceable DPs may have to be interrupted, downgraded, or terminated. The wireless resource allocation, such as channel/bandwidth/schedule, may be mainly handled by the underlying wireless system. In examples, a DP (e.g., a WTRU) may not have (e.g., special) service priority in the wireless system, and it may be incapable of influencing the wireless resources allocation. The data collection on this DP may be (e.g., only be) passively adjusted/downgraded/terminated, for example, if the wireless communication quality becomes worse (e.g., which may not be efficient).

A Data Collection Enabler (DCE) may be provided and/or used. A DCE may be a middleware service, and its main functions may be divided into multiple (e.g., four) parts. A DCE may be a network entity and/or a network node.

For example, a part of DCE may include how DCE may optimize blockchain internal processing (e.g., to enable flexibility and adaptability in blockchain systems, as described herein). A DCE may be used to learn the data collection requirements of (e.g., upper-layer) applications (e.g., as DCs). A DCE may customize the processing of the blockchain system according to the specific needs as described in the data collection requirements.

For example, a part of DCE may include how DCE may optimize the data submission process outside the blockchain system (e.g., to enable efficient coordination between the blockchain system and users outside the blockchain system). For example, blockchain users (e.g., DPs) may interact with the blockchain system more efficiently through DCE.

For example, a part of DCE may include a Crowdsourcing-based Information Processor (CIP) mechanism (e.g., to enable effectively preprocessing collected data), which may serve the scenario that before the collected data (e.g., raw data) is written into the blockchain, data (e.g., raw data) preprocessing may be needed.

For example, a part of DCE may include a data collection procedure with proactive wireless resource control. A DCE may interact with the wireless system proactively so that the wireless system may, for example, allocate stable/more wireless resources to the (e.g., important/VIP) DPs (e.g., which may not be VIP wireless subscribers from the wireless system perspective).

An architecture of the Data Collection Enabler (DCE) may be provided and/or used.

A data provider (DP) may refer to the provider of data to be collected, for example, such as various entities in a wireless system. For example, for a WTRU X, various entities in a system may be one or more of the following potential DPs: the current location of WTRU X (e.g., if the network-assisted positioning approach may be used, the gNB, or AMF may be a DP); the current data rate of WTRU X (e.g., WTRU itself or the OAM system may be a DP); whether WTRU X may be reachable (e.g., AMF may be a DP); whether WTRU X loses connection (e.g., AMF may be a DP); the current signal strength of WTRU X (e.g., WTRU X itself may be a DP). The data may be provided via the NEF, for example, if (e.g., when) network functions (e.g., such as the PCF or the AMF) are a DP. The data may be sent from the DP, for example, via a notification. The notification may have been configured in a subscription request

Data Consumers (DC) may refer to entities that (e.g., need to) use/consume collected data. In the example of the Olympic Park, the data consumers may include the upper-level live broadcast/webcast application software (e.g., the application server and/or application clients hosted on WTRUs) and its users. For example, if (e.g., when) a viewer/audience may be looking for a desired anchor, she may send a search request (e.g., which may (e.g., need to) leverage real-time wireless data collected from the wireless system, for example, to discover the desired network anchor (e.g., at the desired location and with a good wireless connection)). In some examples, a viewer may query which network anchors are currently standing in the central square of the park. Such a request may use real-time location data as well. For example, in the system, a NEF may query which WTRUs currently reside in a certain geographic range through interaction with AMF. Similarly, for a network anchor (e.g., who may be webcasting a tennis final), she may need to send live invitations/ads to people who may not enter the stadium but are the high-value viewers for her current streaming. These may also use (e.g., need) real-time location data collected from the wireless system (e.g., AMF may answer questions like which WTRUs currently reside in a particular geographical area). An Application Server and the NWDAF in the (e.g., 5G) system may be examples of data consumers.

A Blockchain System may be used as an efficient distributed sharing medium and provide various advantages compared to centralized shared storage (e.g., cloud storage), such as anti-tampering, traceability, high visibility, etc. Blockchain may be used such that the data collected from DPs may be stored in the blockchain for DCs (e.g., upper-layer applications/users) to access. A blockchain system may include numerous Blockchain Nodes (BCNs), which may be distributed in various places, for example, such as in the cloud or at the edge of the network (e.g., such as co-located with a cellular base station or deployed on a streetlamp, on a vehicle, etc.).

A data submission process may be the process of delivering data collected from a data provider to a blockchain node (e.g., before the blockchain node starts to do any processing for those collected data). For example, if (e.g., when) a wireless base station (e.g., as a DP) collects real-time data about a WTRU A (e.g., such as the real-time geographic location of WTRU A measured by this base station), the base station may submit the data to a BCN X deployed in the Core Network. This process may be defined as a data submission process (e.g., as described herein). The data submission process may occur outside the blockchain system and may be about how entities (e.g., DPs) external to the blockchain system may submit data to the blockchain nodes.

A Data On-chaining Process may occur (e.g., be performed), for example, from the time when the collected data may be received by a blockchain node to the time when the data may be recorded (e.g., successfully recorded) on the blockchain (e.g., and visible/consumable to DCs). The on-chaining process may take place inside the blockchain system. Taking the example of the Olympic Park, if (e.g., when) the real-time wireless data of the network anchor A may be submitted by the base station 1 to a BCN X, the BCN X may start to perform a series of blockchain processing operations, for example, such as verifying the related blockchain transactions, executing consensus protocol, etc., appending the data to the blockchain and making it visible/consumable to DCs (e.g., such as upper-layer webcast applications). For example, the on-chaining process may involve a series of blockchain processing operations.

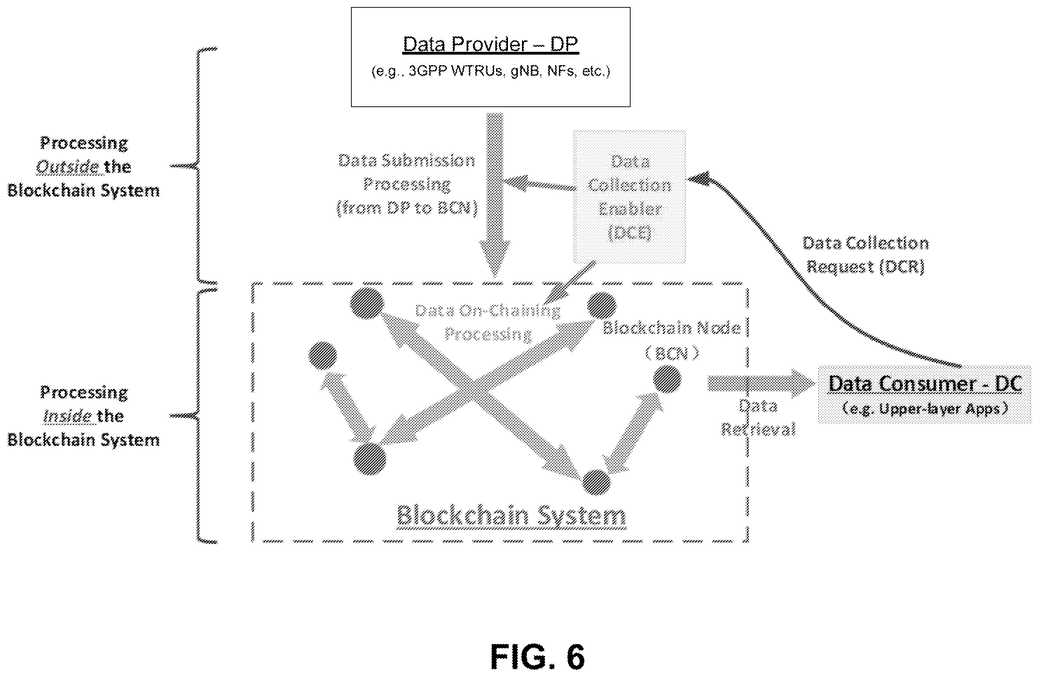

FIG. 6 illustrates an example architecture of the Data Collection Enabler (DCE). A Data Collection Enabler (DCE) may be provided and/or used. A DCE may be a service entity. Its functions may be divided into multiple parts, for example, four parts, as shown in FIG. 6.

The DCE may optimize blockchain internal processing. The DCE may be used to collect the data collection requirements of upper-layer applications (e.g., as DCs), for example, which wireless data needs to be collected and how long the delay of the data on-chaining process may be tolerated, etc. The DCE may customize the processing of the blockchain system according to the specific needs described in the data collection requirements. For example, a customized blockchain processing may execute a specific/selected consensus protocol, for example, to achieve the minimum data on-chaining delay. Procedures (e.g., using the DCE proposed as described herein) may be related to one or more of the following operations: setting up and configuring a blockchain system for supporting customizable blockchain processing (e.g., as described herein); and/or using a customized blockchain system for data collection (e.g., as described herein).

The DCE may optimize the data submission process outside the blockchain system. For example, blockchain users (e.g., DPs) may be able to interact with the blockchain system (e.g., more efficiently) through DCE. Coordination between DPs may be improved (e.g., as described herein).

A Crowdsourcing-based Information Processor (CIP) mechanism may be provided and/or used. Before the collected data (e.g., raw data) may be written into the blockchain, data (e.g., raw data) preprocessing may be used (e.g., needed). 3rd-party entities' capability or computing capacities may be leveraged. For example, a smart contract may incentivize the 3rd-party entity to participate as CIPs with certain rewards (e.g., as described herein). It may be possible that an (e.g., one single) entity may (e.g., only) have limited CIP capability. Information processing may be conducted in a crowdsourcing-based approach, for example, in which different CIPs may work collaboratively to process the data (e.g., raw data) collected from DPs (e.g., as described herein).

A data collection procedure with proactive wireless resource control may be provided and/or used. DCE may interact with the wireless system proactively, for example, so that the wireless system may allocate stable/more wireless resources to the important/VIP DPs (e.g., which may not be VIP wireless subscribers from the wireless system perspective), for example, as described herein.

Blockchain technology may be a (e.g., generic) term to represent a broader distributed ledger technology. Blockchain technology and distributed ledger technology may be used synonymously or interchangeably as described herein. The embodiments described herein may apply to any blockchain technology and/or distributed ledger technology.

The implementations/procedures in this disclosure may apply to other scenarios (e.g., in addition to the wireless data collection scenario), for example, to collect other types of data from other types of systems. For example, the DCE may collect transportation-type of data from a city transportation system, if the DCE may be to support a blockchain-based smart city application. In the meantime, to reduce the storage load of the blockchain, it may be possible that the data generated by DPs may be stored in another offline storage system (such as InterPlanetary File System, or IPFS) while the hash of the data or the access address of the data may be stored in the blockchain. The implementations/procedures in this disclosure may also be applicable to this scenario. For example, a DC may be (e.g., only) willing to retrieve the desired data from a trusted/authentic access address (e.g., only) if/after the data access address may be successfully recorded in the blockchain via the data on-chain process.

The proposed implementations/procedure may be applicable for meeting other types of data collection requirements/needs. For example, in addition to the data collection requirements related to data on-chaining delay, it may be used for such purposes as using customizable block size, using customizable transaction format, and the like.

A (e.g., 5G) system may be a typical example of a wireless system. The proposed implementations/procedures may also be used to collect wireless data from other (e.g., future generations of) systems (e.g., 6G and beyond) and any other types of wireless systems.

The proposed implementations/procedures may use one or more of the following as examples of entities in the wireless system: cell phones, WTRUs, base stations, network functions, etc. The proposed implementations/procedures may be applied to any terminals or entities, for example, such as but not limited to laptops, Internet-of-Things devices, equipment, future cellphones, drones, roadside units, laptops, TV set-top boxes, gateways, access points, satellites, sensor nodes, robots, machines, routers, base stations, radio access network central units, radio access network distribution units, radio access network radio units, network functions in 5GS and/or 6GS, etc.

A dynamic configuration of a blockchain system may be provided and/or used. For example, a dynamic configuration of a blockchain system may be used to support customizable blockchain processing.

For example, a flexible and customizable blockchain system may be set up and/or built through DCE. DCE may be used to build a blockchain that meets the needs of upper-level data consumers, for example, according to a received Data Collection Request (DCR) initiated by a DC. For example, in the example of the Olympic Park, if a live webcasting viewer wants to search for a qualified network anchor, this may lead to the creation of a DCR, for example, if data have been requested (e.g., certain wireless data that need to be collected) for answering the search. For example, such a DCR may (e.g., need to) collect the real-time location and signal strength information of multiple network anchors. The information may have to be on-chain with the minimum delay, for example, such that the information may be consumed by the DCs (e.g., within the shortest time interval). The DCE may set up and configure a blockchain network (e.g., that may support very short and deterministic on-chaining delay), for example, to serve this DCR. The customized blockchain processing may involve multiple (e.g., two) phases. The customized blockchain processing may involve a phase associated with setting-up/configuring a customizable blockchain system. The customized blockchain processing may involve a phase associated with a data collection process using the customized blockchain system.

A customizable blockchain system may be set-up and/or configured.

A DC may (e.g., in a first phase) submit a DCR to DCE, for example, which may specify the type of data to be collected, and how much delay may be tolerable before the data may be recorded (e.g., successfully recorded) in the blockchain (e.g., and accessible to the DC for usage). The DCE may (e.g., first) determine (e.g., figure out) what data may be to be collected, from which wireless entities, and in which area, for example, based on the received DCR. The DCE may convey (e.g., certain) search criteria to the wireless system, for example, to identify qualified potential DP(s). For example, in the example of the Olympic Park, real-time wireless signal strength information may be obtained from the network anchor's mobile phone, for example, via an OAM system. Real-time location may be measured, for example, either via WTRU, via a serving base station, or via an NEF. Various entities in the wireless system may be DPS, for example, such as WTRUs, base stations, NFs in the core network, etc. According to the DC requirements as described in the DCR (e.g., the performance metric related to data on-chaining delay and/or other types of metrics), the DCE may set up and configure a customizable blockchain network (e.g., that meets the needs of this particular DCR).

An architecture of a customizable blockchain network where blockchain processing may be customized to consider the needs of upper-layer applications (e.g., DCs/DPs) may be provided and/or used (e.g., alternatively). As a result, the customized blockchain system may operate in an application ware manner (e.g., an application-need-aware manner).

The DCE may conduct one or more of the following operations; for example, assuming that the DCE has received a particular DCR-1.

The DCE may use a first blockchain network as the Control Data Blockchain (CDB). The CDB may be a standard or traditional blockchain system. For example, it may run popular blockchain consensus protocols (e.g., PoW, PoS, etc.). The CDB may be used to store the received DCR-1. The CDB may store the operation specification/guideline (e.g., as decided by DCE) of another blockchain network (e.g., Application Data Blockchain or ADB, as described herein). CDB may also store information of ADB, such as its adopted block size, adopted transaction format, etc.

The ADB may be used to store the collected data used (e.g., required) by DCR-1, for example, such as the requested real-time wireless data. The operation of ADB may (e.g., must) be carried out in accordance with the operating specification (e.g., as described in the CDB). For example, a process affecting data on-chaining delay may be caused by the execution of the consensus protocol. To reduce the data on-chaining delay, in the ADB, a (e.g., each) BCN may not adopt the traditional consensus protocol and store the application data. The consensus process may be realized (e.g., in comparison), for example, based on a deterministic BCN scheduling (e.g., this type as well as other types of control data may be stored in CDB). An advantage may be that the data on-chaining delay may be controllable. For a given DCR-1, a specific ADB-1 and CDB-1 may be created. Multiple DCRs may share the same CDB. Multiple DCRs may (e.g., additionally) share the same ADB, for example, if the DCRs have the same requirements for the ADB, and the ADB may handle the workloads for (e.g., all of) the DCRs.

An example to introduce the details of BCN scheduling may be considered. It may be assumed that in the ADB, six blockchain nodes may perform data on-chaining operations (e.g., those BCNs may receive the collected data submitted by DPs), the following round-robin-based BCN scheduling (as the operating specifications/guideline of ADB) may be decided and stored in the CDB every m time units (e.g., one time unit may refer to one minute). For example, m units/minutes may be counted as a (e.g., one) data on-chaining round. In a (e.g., each) round, a BCN (e.g., a unique BCN) may be designated as the winner of this round. In a given round, (e.g., only) the winner BCN (e.g., as specified by the BCN scheduling) may perform data on-chaining operations (e.g., submitting its created blockchain block(s)), and those blocks may be agreed/accepted by other BCNs (e.g., to achieve the global consensus). For example (e.g., assuming the round-robin-based scheduling specifies the following order: BCN-1, BCN-6, BCN-3, BCN-2, BCN-5, BCN-4), in the first round, BCN-1 may be the winner, and in the second round, BCN-6 may be the winner, and so on.

This may eliminate the node contention process (e.g., in the traditional consensus protocol), which may (e.g., greatly) save the time of the data on-chaining process. This contention-less data on-chaining process (e.g., based on BCN scheduling) may not mean there is no contention or consensus process. A consensus process (e.g., traditional consensus process) may happen in an earlier stage, for example, if (e.g., when) deciding the BCN scheduling. For example, (e.g., all) the involved BCNs in the ADB may (e.g., still) conduct a negotiation process, for example, to reach the global consensus for a given BCN scheduling proposal. A PoW-based consensus process may (e.g., alternatively) be conducted between the BCNs in ADB (e.g., to decide a BCN schedule). A BCN scheduling may be (e.g., officially) written into CDB, for example, if (e.g., after, only after) reaching the global consensus. The BCN scheduling decision written into CDB may (e.g., because/since CDB may be any existing blockchain system) become the official operating guideline of all the BCNs in the ADB, for example, because (e.g., since) such scheduling may be traced and may be anti-tempered. The (e.g., all) BCNs in the ADB may (e.g., need to) follow a BCN scheduling, for example, if (e.g., once) this scheduling is (e.g., formally) written into the CDB.

A BCN may submit a smaller block, for example, if the BCN does not have enough data to submit in its own round. The block size in ADB may be variable. The BCN may end the round (e.g., earlier) and may notify the winner of the next round according to the decided BCN scheduling information (e.g., accordingly, DPs and DCE may (e.g., need to) be notified that the next round may be started earlier than scheduled), for example, if (e.g., when) a BCN in ADB has completed one or more its data on-chaining operations in the current round and has not used up the m minutes in this round.

CDB and ADB may be built (e.g., as described herein).

For the ADB, virtual blockchain technology may be utilized. A virtual blockchain may be built on a set of real physical BCNs. Given a set of physical BCNs, various virtual blockchain networks may be created based on needs (e.g., for serving different received DCRs). A (e.g., each) virtual blockchain network may adopt a (e.g., completely) different/individual operating mechanism (e.g., such as a different consensus protocol, or a different BCN scheduling).

For the CDB, because (e.g., since) it (e.g., still) may use the traditional blockchain processing, (e.g., any) existing blockchain system may be leveraged. For example, a PoW-based blockchains system may be used. A virtualized blockchain may (e.g., alternatively and/or additionally) be created specifically for the purpose of CDB.

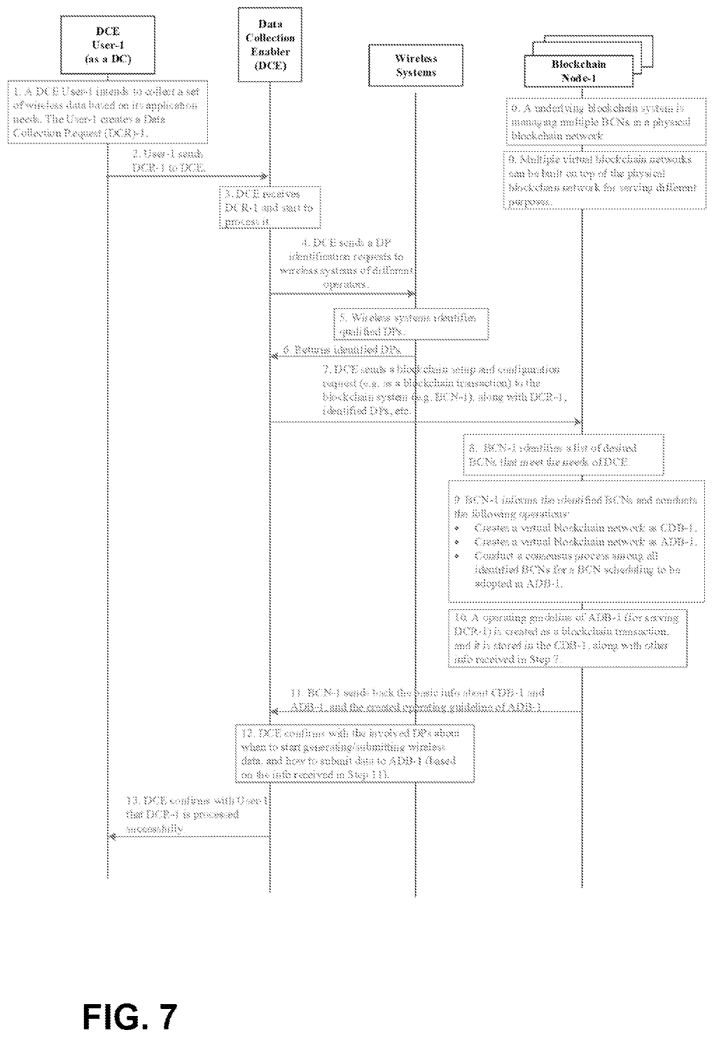

A procedure may be used and/or provided to set up and configure a customizable blockchain system, for example, based on a received DCR (e.g., as illustrated in FIG. 7). FIG. 7 illustrates an example procedure that may be used for setting up and/or configuring a customizable blockchain for a DCR. The procedure (e.g., as shown in FIG. 7) may present the general working procedure of DCE (e.g., network node and/or network entity). How DCE may affect other systems may depend on different implementations and/or procedures. For example, the proposed DCE may be an individual middleware service, or it may be (e.g., new) NFs inside the system (e.g., as described herein).

A pre-condition may be provided and/or considered (e.g., as shown at 0 in FIG. 7). An underlying blockchain system may manage multiple BCNs in a physical blockchain network. Multiple virtual blockchain networks may be built on top of the physical blockchain network for different purposes.

As shown in at 1 in FIG. 7, a DCE User-1 may (e.g., intend to) collect a set of data, for example, based on its application requests and/or parameters (e.g., needs). User-1 may create a Data Collection Request (DCR)-1. The users of DCE may be DCs who want to collect/use certain collected data. In examples (e.g., the Olympic Park use case), the upper-layer live webcast application software may be the user of DCE. DCE User-1 may determine the identity of DCE to contact. The determination may be based on the type of data to be collected and the identity of the entity that created the data. For example, the determination may be based on an identity (e.g., external identifier) of the WTRU that may be associated with the data. In an example, the DCR may also be embodied as a registration request of a DCE User-1 to the DCE.

As shown at 2 in FIG. 7, User-1 may send DCR-1 to DCE. A DCR may describe the details regarding the type of data to be collected. For example, a DCR may include one or more (e.g., but not necessarily one or more) of the following information (e.g., which may be carried in the request at 2 in FIG. 7): the type of data to be collected; the type of terminals, entities, or network functions that may provide those data (e.g., as DPs) or what specific terminals, entities, or network functions may provide the data; DP selection criteria, for example, User-1 may (e.g., only) want to collect data from a given geographical area, and therefore, (e.g., only) DPs residing in this area may be considered; target entities IDs; data collection approach; covered time period; and/or data sampling rate; tolerable on-chaining delay (e.g., maximum tolerable on-chaining delay).

For example, a DCR may include targeted entities IDs. DPs may be entities who create/provide the desired data. The targeted entities may refer to who the data may be to describe. For example, (e.g., with respect to DCR-1), the wireless data to be collected may be the (e.g., real-time) location information of a list of targeted WTRUs (e.g., those WTRUs may be acting as network anchors in the Olympic Park). The (e.g., real-time) location information of those WTRUs may be provided/measured by the (e.g., serving gNB) base stations or other entities as DPs (e.g., via network-assistant localization). The list of targeted WTRUs may be a list of external identifiers or a list of IP addresses.

For example, a DCR may include a data collection approach. Multiple (e.g., two) types of data collection approaches may exist. An approach may be used for real-time data collection. In examples for a data collection approach for real-time data collection, (e.g., real-time) data may be submitted (e.g., immediately) to the blockchain system (e.g., once a DP generates a piece of real-time data), for example, to achieve the minimum data on-chaining delay. An approach may be the batch approach, in which the data may be collected in batch. For example, (e.g., some) historical/archival wireless data (e.g., historical mobility or signal strength data in the past two days) may be collected by using this approach.

For example, a DCR may include a covered time period. A covered time period may indicate the preferred time period for collecting the desired data. For example, the user may (e.g., only want to) collect historical signal strength data of various network anchors in the last two days. For example, the user may a want to collect data when they were inside the Olympic park.

For example, a DCR may include a data sampling rate. The data sampling rate parameter may be (e.g., often) used, for example, if (e.g., when) the real-time data collection approach may be adopted. For example, the DCs may (e.g., prefer to) receive a location update at a time interval (e.g., every two minutes) for a (e.g., each) targeted WTRU, for example, if (e.g., when) real-time locations of targeted WTRUs are (e.g., need) to be collected in real-time.

For example, a DCR may include a (e.g., maximum) tolerable on-chaining delay. A (e.g., maximum) tolerable on-chaining delay may indicate how much on-chaining delay the DCs of DCR-1 may tolerate. For example, the real-time wireless data may have the minimum on-chaining delay (e.g., normally), which may mean that the collected data may be on-chain and available to DCs (e.g., as soon as possible). Other types of performance metrics may also be added, such as maximum data size, etc.

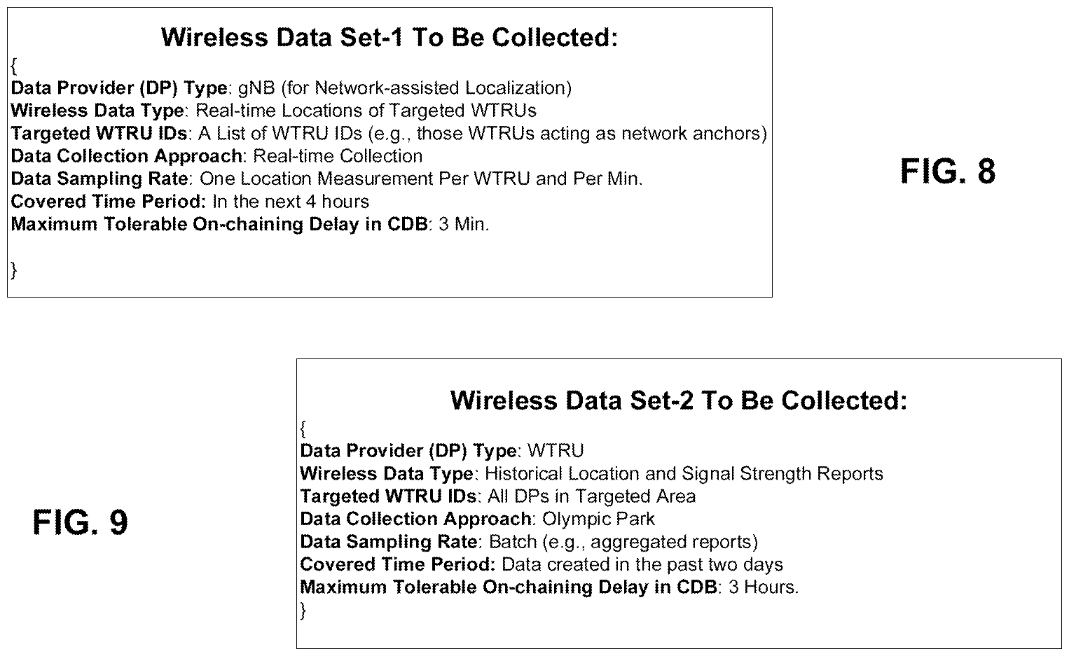

FIG. 8 shows an example of a DCR (e.g., DCR-1) collecting the real-time locations of a list of one or more targeted WTRUs. For example, those targeted WTRUs may be (e.g., currently) personal network anchors in the Olympic Park (e.g., this information may be obtained from the DC side, for example, the upper-layer live webcast applications), which may be indicated by the Targeted WTRU IDs parameter. The data may be collected from the (e.g., serving gNB) base stations (e.g., using the network-assisted localization approach). The DCs of DCR-1 may (e.g., intend to) get a location update periodically (e.g., for every minute), for example, and may (e.g., want to) cover a duration (e.g., the next 4 hours), for example, because the Olympic park may be closed after the duration (e.g., four hours). The user may (e.g., only) tolerate the data on-chaining delay for a period of time (e.g., of up to 3 minutes). FIG. 9 shows a DCR (e.g., DCR-2) that may be used for collecting historical location/mobility data. DCR-2 (e.g., which may differ from DCR-1) may (e.g., intend to) collect historical data directly from WTRUs. The DCR-2 may specify DP selection criteria that (e.g., all) the WTRUs (e.g., in the Olympic Park) for a duration of time (e.g., in the past two days) may potentially be DPs for DCR-2. In addition, the user may tolerate an (e.g., maximum) on-chaining delay of up to a period of time (e.g., 3 hours), for example, because (e.g., since) DCR-2 may collect historical wireless data.

As shown at 3 in FIG. 7, a DCE may receive DCR-1 and (e.g., start to) process it. The DCE may be involved with one or more of the following tasks: based on the needs as described in the DCR-1, the DCE may (e.g., need to) identify the qualified DPs, for example, which may be various entities inside the wireless systems (e.g., such as WTRUs, base stations, NFs in the core networks, etc.), and the task may be conducted as shown at 4-6 in FIG. 7. A customized blockchain system may (e.g., need to) be set up and configured, for example, which may be conducted as shown at 7-11 in FIG. 7.

As shown at 4 in FIG. 7, the DCE may send a DP identification request to the wireless systems of different operators. The (e.g., potential) DPs may come from different wireless systems. For example (e.g., with respect to DCR-1), the real-time location of multiple WTRUs (e.g., acting as network anchors in the Olympic Park) may be collected. Those network anchors may use different wireless operators. The DCE may (e.g., need to) contact different operators. One or more of the parameters (e.g., all the parameters) included in the DCR-1 may be sent to cellular systems of different operators, for example, for DP identification.

As shown at 5 in FIG. 7, the wireless system may conduct its own processing (e.g., to discover qualified DPs). The wireless system may conduct its own processing to discover qualified DPs after receiving the DP identification request. Taking the system as an example, the DCR-1 may have (e.g., already) provided a list of targeted WTRUs acting as network anchors in the Olympic Park and DCR-1 may have been received by the NEF of the system. The NEF may interact with various NFs (e.g., such as NDR/AMF/LMF/etc.). The NEF may use procedures to interact with various NFs, for example, to identify potential DPs. For example, the real-time location of targeted WTRUs may be measured/generated by the (e.g., serving gNB) base stations covering the Olympic Park. Those gNB base stations may be the identified DPs. A network function in the wireless system (e.g., the NEF) may obtain a key from a DP (e.g., each DP). The network function may obtain a key from a DP that may be used to track, charge, and authorize subsequent data requests.

As shown at 6 in FIG. 7, the wireless system may return a list of identified DPs, for example, that may provide desired wireless data for serving DCR-1. The list may include a key for identified DP that may be used to provide that a subsequent data request may be authorized.

As shown at 7 in FIG. 7 (e.g., assuming that existing operating blockchain systems may not meet the needs of DCR-1), the DCE may send a customizable blockchain setup and configuration request (e.g., as a blockchain transaction), for example, to BCN-1 in the physical blockchain system (e.g., to set up a (e.g., new) blockchain system for serving the needs of DCR-1). There may be multiple (e.g., a number of possible) implementation cases. For example, BCN-1 may provide DCE with the management capability and customization services for the blockchain system. Therefore, the DCE may send the request to BCN-1. There may be an external management function or entity for BCN node management, for example, where (e.g., in this case) the DCE may send the request to this management entity (e.g., which may further interact with BCNs). It may be assumed that both CDB and ADB may adopt virtual blockchain technology. One or more of the following parameters may be included in the request: (e.g., all) the parameters in the DCR-1; (e.g., all) the identified DPs and their associated keys; parameters associated with the need for the CDB and ADB to be created for serving DCR-1; and/or the like.

Parameters associated with the need for the CDB and ADB to be created for serving DCR-1 may be included in the request. The parameters may include (e.g., for CDB) how many BCNs may be needed for the virtual blockchain network to be created (e.g., as CDB). DCE may also suggest using (e.g., any) existing (e.g., virtualized or non-virtualized) blockchain systems, for example, if they may meet the needs of DCR-1 as its CDB. If not, a (e.g., new) CDB may (e.g., need to) be set up. The parameters may include (e.g., for CDB) the selection criteria for BCN in CDB. For example, DCE may request that a (e.g., each) participating BCN in CDB may be a computing node (e.g., a powerful computing node) with sufficient storage/memory resources (e.g., such that computing-intensive consensus protocols, such as PoW, may be run). The parameters may include (e.g., for CDB) what consensus protocol may be adopted by involved BCNs in CDB. For example, DCE may suggest using a consensus protocol for CDB, such as the traditional PoW protocol or any other consensus protocol. The parameters may include (e.g., for CDB) the block size in CDB. For example, DCE may suggest using a fixed blockchain block size. The parameters may include (e.g., for CDB) a (e.g., any) suggested blockchain transaction format to be used in CDB. By adopting the virtual blockchain technology, the underlying physical blockchain system (e.g., if/when DCE sends a blockchain transaction carrying DCR-1 to the BCN-1 in the physical blockchain system) and the virtualized blockchain systems built on top of it (e.g., the CDB and ADB created for serving DCR-1) may adopt different transaction formats.

The parameters may include (e.g., for ADB) how many BCNs may be used (e.g., needed) for the virtual blockchain network to be created (e.g., as ADB). The DCE may (e.g., additionally and/or alternatively) suggest using (e.g., any existing virtualized or non-virtualized) blockchain systems, for example, if it may meet the needs of DCR-1 as its ADB. If not, a (e.g., new) ADB may (e.g., need to) be set up. The parameters may include (e.g., for ADB) the selection criteria for BCN in ADB. For example, DCE may require that a (e.g., each) participating BCN in ADB may be close to the Olympic Park, or it may be beneficial if a BCN may be directly inside the park. A (e.g., each) BCN in ADB may be able to process the expected data volume as estimated by DCE. The parameters may include (e.g., for ADB) what consensus protocol may be adopted by involved BCNs in ADB. For example, an ADB may adopt an existing consensus protocol. In an example, the ADB may adopt a Do-It-Yourself (DIY) consensus protocol as discussed herein. For example, a DCE may use (e.g., suggest using) a (e.g., round-robin-based) BCN scheduling as the consensus protocol used in ADB for serving DCR-1 (e.g., in each BCN scheduling round, there may be a (e.g., only one) winner BCN that may write/record its transaction blocks into the existing blockchain). The parameters may include (e.g., for ADB) block size in ADB. For example, DCE may use (e.g., suggest using) variable blockchain block size. The DCE may indicate other rules or policies regarding how the ADB may operate. For example, the DCE may indicate a time length for a (e.g., each) BCN scheduling round (m) (e.g., 2 minutes). For example, the DCE may indicate if (e.g., when) a BCN in ADB has completed (e.g., all) its data on-chaining operations in its current round and has not used m minutes. The BCN may end the current round in advance and notify the winner of the next round according to the decided BCN scheduling information. The parameters may include (e.g., for ADB) a (e.g., any) suggested blockchain transaction format to be used in ADB to store the collected data of DCR-1.

Prior to sending the blockchain setup and configuration request (e.g., as shown at 7 in FIG. 7), the DCE may identify a BCN to send the request to. The DCE may make this determination based on the data to be stored in the blockchain, and the access latency requirements for the stored data. It may be assumed that BCN-1 has been identified that has the potential for serving DCR-1.

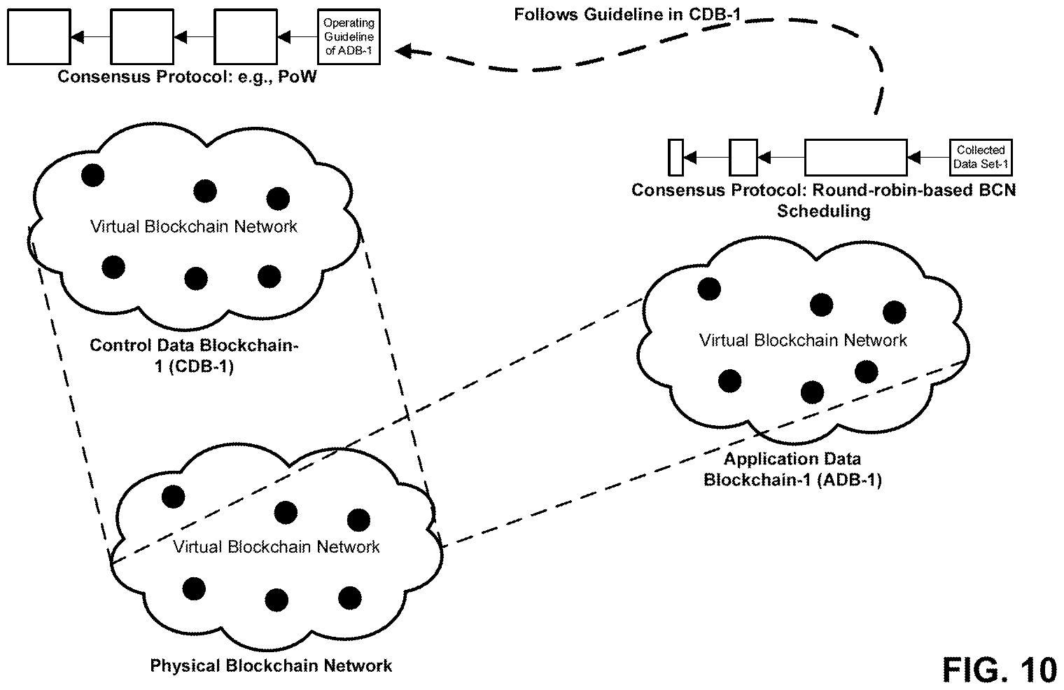

As shown at 8 in FIG. 7, the BCN-1 (e.g., as well as other BCNs in the physical blockchain network) may host a knowledge repository (e.g., regarding other BCNs). The BCN-1 may identify a list of (e.g., desired) BCNs that may meet the needs of the DCE (e.g., for creating the needed CDB-1 and ADB-1). For example, it may be assumed that the (e.g., same) set of (e.g., six) BCNs were selected to create two virtualized blockchain networks (e.g., CDB-1 and ADB-1 for the DCR-1, respectively, which may be shown in FIG. 10). FIG. 10 illustrates an example of a created CDB-1 and/or ADB-1 for serving DCR-1 using virtualized blockchain technology.

As shown at 9 in FIG. 7, the BCN-1 may inform the identified BCNs and may complete one or more of the following actions: the BCN-1 may (e.g., first) contact those identified BCNs and may confirm their willingness to join the CDB-1 and ADB-1; the BCN-1 may create a virtual blockchain network as CDB-1 for serving DCR-1; and the BCN-1 may create a virtual blockchain network as ADB-1 for serving DCR-1.

There may be different ways regarding how to decide a BCN scheduling for the BCNs in ADB-1. For example, in an example approach, the BCN scheduling may be decided via CDB-1. For example, it may be assumed that there are six BCNs (e.g., denoted as k=6) in the ADB-1 and CDB-1 may be using a traditional PoW consensus protocol. Accordingly, the following rules (e.g., algorithm) may be used by BCN-1 to form a BCN scheduling: for a round (e.g., each round) in CDB-1 (e.g., using PoW), it monitors who may be the winner for this round i; assuming the winner of round i may be the BCN having node ID p, then it may calculate x=p mod(k+1) (e.g., x may be ranged from 1 to k); if x may be not in the current BCN scheduling list, it may be added; otherwise, no action may be performed (e.g., may be needed). The rules (e.g., algorithm) may be terminated, for example, if (e.g., when) the (e.g., all the) k BCNs are included in the BCN scheduling list, for example, which may be the decided BCN scheduling for BCN nodes in ADB-1. In an example approach, BCNs in ADB-1 may conduct a negotiation process (e.g., any type of negotiation process may be adopted, and this process may be to reach an agreement for BCN scheduling) by themselves in order to decide a BCN scheduling. In an example approach, assuming that a BCN (e.g., each BCN) in ADB-1 may know which BCNs may be participating in ADB-1 (e.g., six nodes). A BCN (e.g., each BCN) may propose its own BCN scheduling and may include it into a transaction. For example, BCN-1 may propose a BCN scheduling as BCN-3, BCN-2, BCN-6, BCN-4, BCN-5, BCN-1 and may include such a scheduling in Transaction-1. BCN-2 may propose another BCN scheduling as BCN-2, BCN-4, BCN-5, BCN-6, BCN-3, BCN-1 and may include such a scheduling in the Transaction-2. Similar to other BCNs, BCN-X may propose a BCN scheduling and may include the BCN scheduling in Transaction-X). A (e.g., a) BCN may send their respective transactions to a blockchain system, e.g., CDB-1, which may adopt an existing consensus protocol (such as PoW). The transactions, which may include the schedulings proposed by the different BCNs, may be recorded in a chronological order (e.g., Transaction-2 may be recorded first in the ADB-1, then Transaction-1, Transaction-4, Transaction-5, Transaction-3, Transaction-6). A final BCN scheduling CDB-1 may be decided as follows: in the first six (m) time units, the BCN scheduling included in the Transaction-2 may be applied; in the second six (m) time units, the BCN scheduling included in the Transaction-1 may be applied; in the third six (m) time units, the BCN scheduling included in the Transaction-4 may be applied, so on so forth. It may be repeat when the BCN scheduling included in Transaction-6 may be applied.

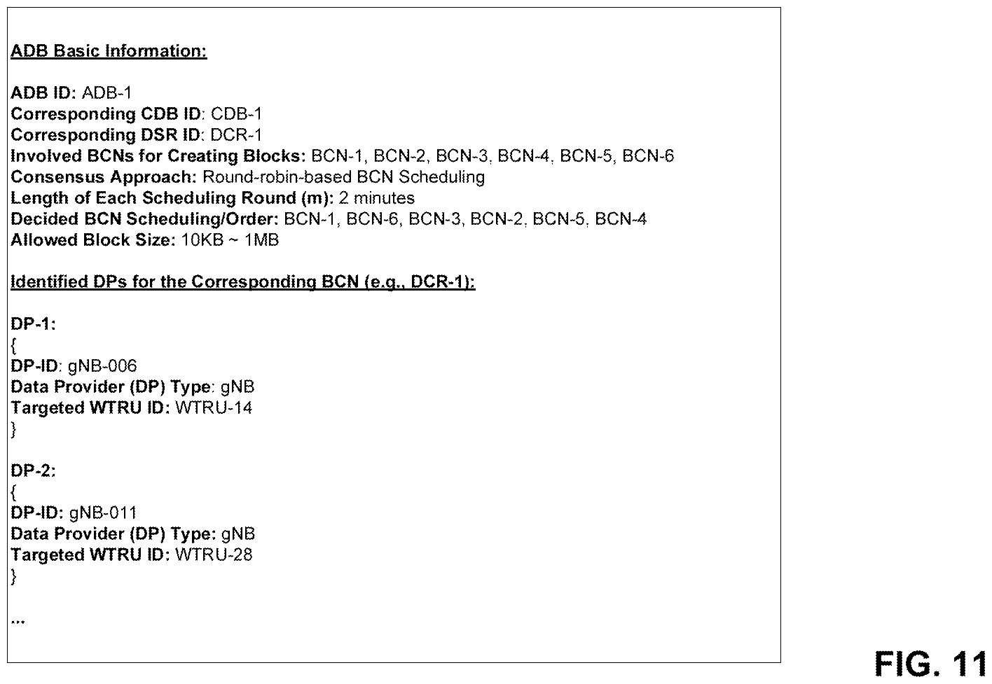

As shown at 10 in FIG. 7, blockchain transactions may be created according to the transaction format of CDB-1, for example, in order to record the DCR-1, (e.g., all) the information about the created ADB-1/CDB-1, the operating guideline of ADB-1, and (e.g., all) other information described at 7 and 9 in FIG. 7. FIG. 11 illustrates an example of an operating guideline for serving DCR-1. Other basic information of ADB-1 may also be recorded, such as its adopted transaction format, adopted blockchain size, etc.

As shown at 11 in FIG. 7, (e.g., assuming that BCN-1 provides the management capability/services for the blockchain system) BCN-1 may send back (e.g., basic) information about created CDB-1 and ADB-1 to DCE (e.g., alternatively, if an external management function or entity exists for BCN node management, such an entity may send back the basic information to DCE). This information may be used by the DCE to know one or more of the following: which BCNs may be involved in the CDB-1; the blockchain transaction format of CDB-1; which BCNs may be involved in the ADB-1; the operating guideline of ADB-1; the blockchain transaction format of ADB-1; and/or the access details of those involved BCNs, for example, how to submit blockchain transactions to a particular BCN in ADB-1.

As shown at 12 in FIG. 7, the DCE may confirm with the involved DPs about when to start generating/submitting the (e.g., needed) data. Multiple ways for submitting data (e.g., depending on different implementation choices) to the ADB-1 (e.g., based on the info received in 11) may be provided and/or used (e.g., as described herein with respect to DPs submitting to the DCE and DCE further submitting the wireless data to the blockchain, and (e.g., alternatively) the DCE conveying the DPs with the access details of the blockchain nodes so that DPs may directly submit their data to the blockchain).

As shown at 13 in FIG. 7, the DCE may confirm with a user (e.g., User-1) that DCR-1 has been processed successfully.

The procedure (e.g., as described herein with respect to FIG. 7) may be further leveraged for modifying, updating, and/or deleting a customized blockchain system, for example, depending on the dynamic needs. The BCN scheduling may be modified dynamically, for example, if a new BCN node may be added in ADB-1 or an existing BCN may be deleted from ADB-1.

A DCE in a phase (e.g., second phase, Phase 2) may perform a data collection process using the customized blockchain system.

In a (e.g., second) phase, the data collection process may be conducted based on a (e.g., created) customized blockchain system (e.g., that was set up and configured, for example, during a previous phase, such as the first phase as described herein). A number of different approaches may be used for the data collection process. The approaches may have their own applicable application scenario. For illustration purpose, DCR-1 may be used as an example.

In a first approach (e.g., Approach-1), DPs may not (e.g., need to) be involved with the data submission process and data on-chaining process. The DCE may (e.g., in comparison) ask DPs to submit their data to DCE (e.g., first). The DCE may be implemented as a fully-distributed service, for example, in the sense that multiple DCE agents may be deployed in different areas. It may be DCE's responsibility for deciding how to further submit the collected wireless data to the appropriated BCNs. The first approach (e.g., Approach-1) may reduce (e.g., have an advantage that it reduces) the workload/burden to DPs. For example, DPs may not (e.g., have to) understand (e.g., any) interaction details regarding how to communicate with the blockchain system, how to create blockchain transactions, and/or based on which transaction format, etc. DPs (e.g., instead) may (e.g., need to) generate data (e.g., raw data), for example, which may be useful for the case where DPs are resource-constrained entities/devices. The first approach (e.g., Approach-1) may be applicable to the scenario where there may be no BCN deployed inside the wireless system and DCE (e.g., needs to) collects the desired wireless data from the wireless system and submit those data to an external/customized blockchain system (e.g., ADB-1 as created in a first phase, such as, Phase 1).

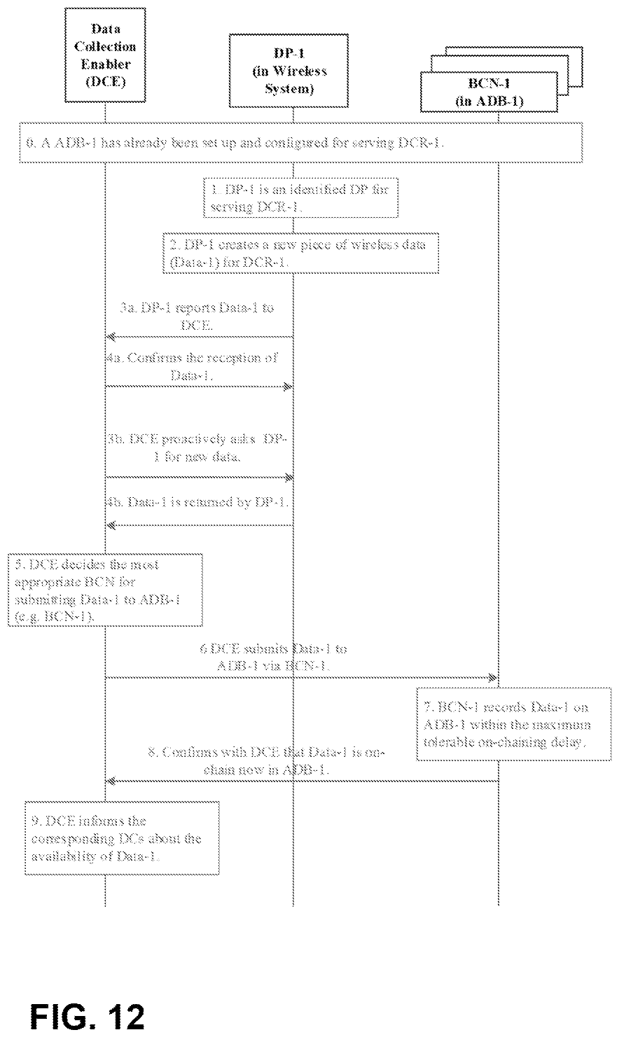

A (e.g., new) procedure may be used for the first approach (e.g., Approach-1), as shown in FIG. 12. FIG. 12 illustrates an example procedure that may be used as a data collection process via a DCE.

As shown at 0 in FIG. 12 (e.g., Precondition), ADB-1 may be set up and configured (e.g., already been set up and configured) for serving DCR-1. The collected data to be used (e.g., needed) by DCR-1 may be stored in ADB-1.

As shown at 1 in FIG. 12, DP-1 may be an identified DP for serving DCR-1. In examples (e.g., the Olympic Park example), DCR-1 may be illustrated in FIG. 8, which may collect the real-time location of a list of targeted WTRUs acting as live network anchors. DP-1 may be a serving gNB base station, for example, which may measure real-time locations of WTRUs acting as network anchors.

As shown at 2 in FIG. 12, DP-1 may create a (e.g., new) piece of wireless data (e.g., Data-1) for DCR-1. For example, based on the requests and/or parameters (e.g., needs) as described in the DCR-1, the potential DCs may (e.g., need to) get real-time location updates for the (e.g., each) targeted WTRU periodically (e.g., every two minutes). Data-1 may be a piece of the real-time location of a particular targeted WTRU.

In examples, it may be assumed that during the DP identification stage, one or more DPs have been selected. For example, the DPs may be configured so that they may (e.g., proactively) report the (e.g., needed) wireless data to the DCE, as illustrated in 3a-4a in FIG. 12.

As shown at 3a in FIG. 12, DP-1 may report the Data-1 to DCE. One or more of the following information may be included in the request: the data content (e.g., Data-1) or a location of the data (e.g., a URI where Data-1 may be obtained);), the DP ID (e.g., DP-1), the data type (e.g., real-time location), the data timestamp (e.g., sampled as Jan. 22, 2022 13:10:20), the corresponding DCR ID (e.g., DCR-1), etc.

As shown at 4a in FIG. 12, the DCE may confirm the reception of Data-1.

In examples (e.g., a second/alternative case), it may be assumed that for the selected DPs, DCE may (e.g., need to) periodically ask those DPs for any generated data (e.g., newly-generated data). This possibility may be illustrated in 3b-4b in FIG. 12.

As shown at 3b in FIG. 12, the DCE may ask DP-1 for newly- or previously-created data periodically.

As shown at 4b in FIG. 12, Data-1 may be returned by DP-1. The parameters that may be included in this request may be the same as the ones included in 3a, as shown in FIG. 12.

As shown at 5 in FIG. 12, the DCE may decide on an appropriate (e.g., the most appropriate) BCN for submitting Data-1 to ADB-1. For example, the DCE may find that Data-1 may be a piece of real-time location data to be used (e.g., needed) by DCR-1, and its maximum tolerable on-chaining delay may be three minutes. The DCE may determine (e.g., know) that Data-1 may be (e.g., needs) to be recorded by ADB-1 (e.g., as soon as possible). The DCE may check the BCN scheduling information of ADB-1. It may be assumed that DCE may identify that (e.g., now) BCN-1 may be the winner for the current data on-chaining round. The DCE may create a (e.g., new) blockchain transaction according to the transaction format of ADB-1 and submit it to BCN-1. The DCE may find that BCN-1 (e.g., already) has a number of transactions to be recorded for its round above a threshold (e.g., too many transactions to be recorded for its round). The DCE may choose to submit the data to the BCN-3, which may be the winner of the next round (e.g., as decided in the BCN scheduling). The DCE may receive multiple types of data belonging to different DCRs, which may have different delay requirements. The DCE may (e.g., need to) set different processing priorities for those data. If the DCE may be processing and submitting (e.g., currently trying to process and submit) a set of Type-1 data (e.g., low-priority data with relatively loose data on-chaining delay requirement), a set of Type-2 data (e.g., high-priority data with stringent data on-chaining delay requirement) may arrive at the DCE. Due to the different priorities, DCE may stop submitting Type-1 data and may (e.g., may immediately help to sublimit) submit Type-2 data to an appropriate BCN, for example, to meet its data on-chaining delay requests and/or parameters (e.g., data on-chaining delay requirement). The approach (e.g., as described herein) may be based on the system setting that DPs may continuously send their data to DCE, and it may be up to DCE to decide the processing priority based on the different data on-chaining delay requirements. The data collection priority control may (e.g., directly) be enforced on the DPs level. For example, the DPs may be configured with various triggers, for example, such that if the triggers are not activated, the DPs may refrain from sending (e.g., not send) their data to the DCE. If the triggers are activated, the DPs may start to generate the data and submit it to DCE for processing. The DCE may dynamically configure (e.g., activate/deactivate) the triggers at the respective DPs. For example, if DCE decides that DP-1 may be to refrain from submitting (e.g., shall not submit) its Type-1 data (e.g., lower-priority data) at the moment (e.g., since DCE may be processing Type-2 data (e.g., high-priority data) sent from DP-2, the DCE may send a trigger to DP-1, for example, so that DP-1 may stop sending Type-1 data to DCE. If the DCE processes (e.g., completes the processing of) Type-2 data (e.g., Type-2 data may already be on the chain), the DCE may send a (e.g., new) trigger to DP-1, for example, so that it may resume the Type-1 data submission to DCE for processing.

As shown at 6 in FIG. 12, the DCE may submit a blockchain transaction (e.g., carrying Data-1) to ADB-1 via BCN-1.

As shown at 7 in FIG. 12, the BCN-1 may win the (e.g., current) data on-chaining round. BCN-1 may pack the received transaction (e.g., carrying Data-1) into a block. The block may be recorded/appended into the ADB-1, for example, with the (e.g., minimum) data on-chaining delay.

As shown at 8 in FIG. 12, the BCN-1 may confirm with DCE that Data-1 may be on-chain in ADB-1.

As shown at 9 in FIG. 12, the DCE may inform the corresponding DCs of DCR-1 about the availability of Data-1. For example, those DCs may start to access ADB-1 for retrieving Data-1.

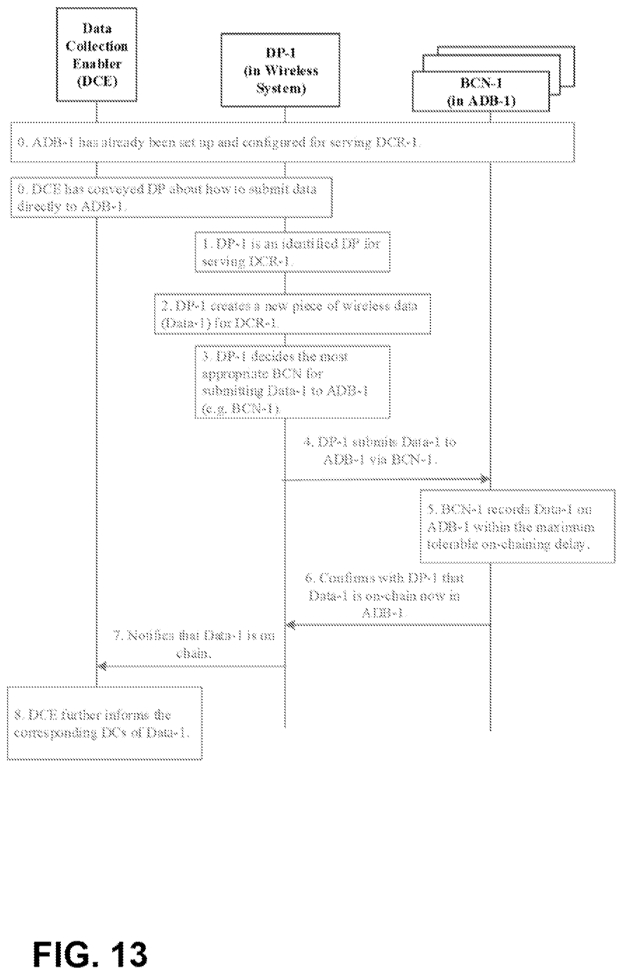

FIG. 13 illustrates another example procedure that may be used as a data collection process via a DCE.

In an approach (e.g., a second approach, Approach-2), the DCE may convey to the DPs (e.g., all) the information (e.g., regarding how to submit collected wireless data to ADB-1) and the DPs may directly interact with BCNs for data submission. A second approach (e.g., Approach-2) may be useful if DPs have capabilities to directly interact with the blockchain system and those DPs may have (e.g., sufficient) resources to do so (e.g., such as powerful laptops, WTRUs, road-side units, etc.). The second approach (e.g., Approach-2) may be used (e.g., desirably used) if a BCN of ADB-1 may be directly available/deployed inside the wireless system (e.g., a BCN may be deployed in an Olympic Park or co-located with a gNB base station) such that the collected data may be directly submitted to BCN within the wireless system.

A (e.g., new) procedure may be used for the second approach (e.g., for Approach-2), for example, as shown in FIG. 13.

FIG. 13 illustrates an example procedure of a direct data collection process (e.g., Approach 2).

As shown at 0 (e.g., Precondition) in FIG. 13, the ADB-1 may be set up and configured (e.g., already set up and configured) for serving DCR-1. The collected wireless data to be used (e.g., needed) by DCR-1 may be stored in ADB-1. The DPs may (e.g., be assumed to) have the capability to interact with the blockchain system directly. During the set-up stage, the DCE may have (e.g., already) conveyed (e.g., all) the information about how to submit the collected data directly to ADB-1.

As shown at 1 in FIG. 13, the DP-1 may be an identified DP for serving DCR-1. In examples (e.g., taking the Olympic Park as an example), DCR-1 may be illustrated in FIG. 8, which may be used to collect the real-time location of a list of targeted WTRUs acting as live network anchors. DP-1 may be a serving gNB base station, for example, which may measure real-time locations of certain WTRUs acting as network anchors.

As shown at 2 in FIG. 13, the DP-1 may create a (e.g., new) piece of wireless data (e.g., Data-1) for DCR-1. For example, based on the needs as described in the DCR-1, the potential DCs may (e.g., need to get real-time location updates for a (e.g., each) targeted WTRU periodically (e.g., per two minutes). Data-1 may be a piece of real-time location of a targeted WTRU.

As shown at 3 in FIG. 13, DP-1 determines the most appropriate BCN for submitting Data-1 to ADB-1 (e.g., BCN-1). For example, DP-1 may determine (e.g., find) that Data-1 may be a piece of real-time location data to be used (e.g., needed) by DCR-1 and its (e.g., maximum) tolerable on-chaining delay may be a duration (e.g., 3 minutes). DP-1 may know that Data-1 may (e.g., need to) be recorded by ADB-1 (e.g., as soon as possible). DP-1 may check the BCN scheduling information of ADB-1 as conveyed by DCE. The DP-1 may (e.g., be assumed to) identify that now BCN-1 may be the winner for the (e.g., current) data on-chaining round. DP-1 may create a (e.g., new) blockchain transaction according to the transaction format of ADB-1 and submit it to BCN-1.

As shown at 4 in FIG. 13, DP-1 may submit Data-1 to ADB-1 via BCN-1. DP-1 may know that the BCN-1 may be the winner BCN of the current round. For example, DP-1 may know based on the BCN scheduling information. BCN-1 may be difficult to be reached. DP-1 may send its transaction to another BCN-2. For example, DP-1 may send its transaction to another BCN-2 that may be close to it. DP-1 may indicate to BCN-2 that Data-1 may (e.g., need to) have a minimum on-chaining delay. In examples, DP-1 may indicate to BCN-2 that Data-1 may be forwarded to BCN-1 (e.g., as soon as possible). If (e.g., once) BCN-2 receives the Data-1, BCN-2 may (e.g., immediately) forward this data to BCN-1 for processing as shown at 5 in FIG. 13.

As shown at 5 in FIG. 13, BCN-1 may win the (e.g., current) data on-chaining round. BCN-1 may pack the received transaction (e.g., carrying Data-1) into a block. The block may be recorded/appended into the ADB-1, for example, within the maximum tolerable on-chaining delay.

As shown at 6 in FIG. 13, if BCN-1 confirms with DP-1 that Data-1 may be on-chain now in ADB-1, BCN-1 may be able to confirm with DP-1 that Data-1 may be on-chain now in ADB-1.

As shown at 7 in FIG. 13, DP-1 may notify DCE that Data-1 may be on a chain in ADB-1.

As shown at 8 in FIG. 13, the DCE may inform the corresponding DCs about the availability of Data-1. For example, those DCs may start to access ADB-1 for retrieving Data-1.

Coordination (e.g., efficient coordination) between different entities may be enabled.

There may be a lack of (e.g., efficient) coordination between the blockchain system and its users outside the blockchain system (e.g., DPs). Efficient coordination may be arranged, for example, depending on different objectives. Procedures may be used to provide coordination between DPs and coordination between DPs and BCNs.

Coordination (e.g., efficient coordination) between different DPs may be enabled.

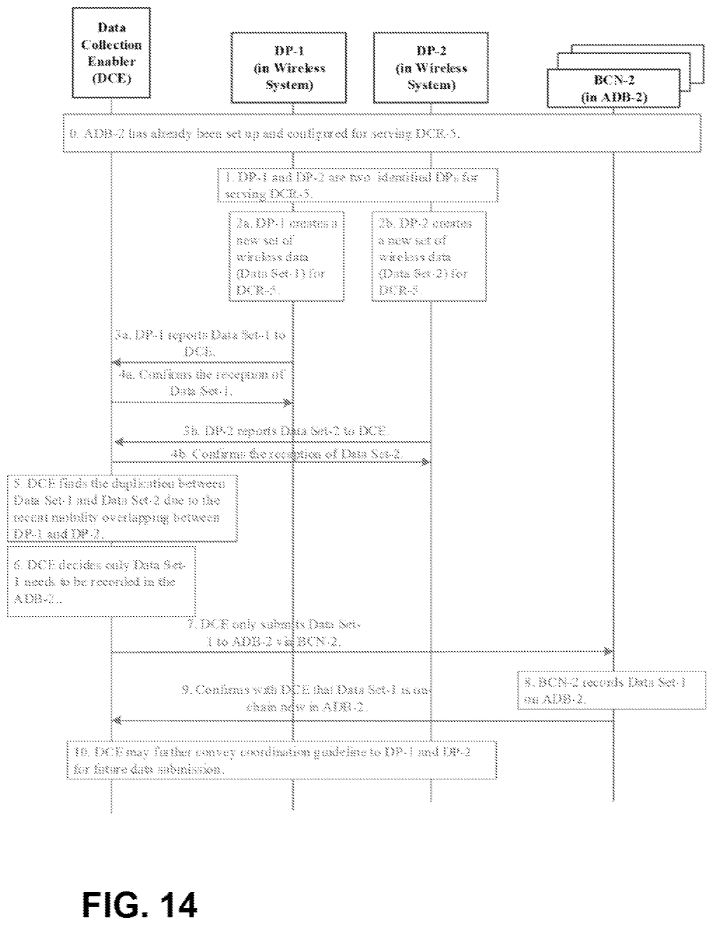

It may be identified that different DPs may generate redundant data (e.g., they are functionally duplicated). The functionally-duplicated data may be submitted by different DPs as different blockchain transactions in the data submission process (e.g., the process for DPs to submit their data to BCNs), for example, which may increase the redundancy of the blockchain system and may add more workload to the blockchain system for processing. Procedures for the data submission process with efficient DP coordination and a detailed procedure of a first approach (e.g., Approach-1, where DP coordination may be realized with the help of DCE) may be illustrated in FIG. 14.

FIG. 14 illustrates an example of a data submission process with DP coordination (e.g., Approach-1: DP Coordination via DCE),

As shown at 0 (e.g., Precondition) in FIG. 14, the ADB-2 may be set up and configured (e.g., have already been set up and configured) for serving DCR-5. DCR-5 may (e.g., be assumed to) be collecting historical cellphone signal strength in different areas of the Olympic Parks.

As shown at 1 in FIG. 14, DP-1 and DP-2 may be two identified DPs for serving DCR-5. For example, DP-1 and DP-2 may be two WTRUs hosted by two network anchors, who may have walked around the Olympic Park for webcasting different sports activities. DP-1 and DP-2 may not know each other. They may stay in the same/similar area at the same time such that they may have similar signal cellphone strength data.

As shown at 2a in FIG. 14, DP-1 may create a (e.g., new) set of wireless data (e.g., Data Set-1) for DCR-5. For example, Data Set-1 may include one or more of the following information: the Data Set-1,the metadata of Data Set-1, etc. The metadata of Data Set-1 may include one or more of the following: the DP ID of the creator of Data Set-1 (e.g., DP-1); the wireless data type (e.g., historical cellphone signal strength); the size of Data Set-1; the covered time period of Data Set-1 (e.g., in the last two hours); the mobility history of DP, for example, if (e.g., when) creating data for Data Set-1 (e.g., Area-1 in the Olympic park); and/or the like.

As shown at 2b in FIG. 14, DP-2 may also create a new set of wireless data (e.g., Data Set-2) for DCR-5.

As shown at 3a in FIG. 14, DP-1 may report Data Set-1 to DCE, for example, along with the metadata of Data Set-1.

As shown at 4a in FIG. 14, the DCE may confirm the reception of Data Set-1.

As shown at 3b in FIG. 14, DP-2 may report Data Set-2 to DCE, for example, along with the metadata of Data Set-2.

As shown at 4b in FIG. 14, the DCE may be able to confirm the reception of Data Set-2.

As shown at 5 in FIG. 14, the DCE may find the duplication between Data Set-1 and Data Set-2, for example, due to the mobility overlapping between DP-1 and DP-2 (e.g., based on the metadata). For example, the DCE may find that Data Set-2 and Data Set-1 may serve the same purpose, for example, because, in the last two hours, both DP-1 and DP-2 were in the same areas (e.g., the Area-1 of the park).

As shown at 6 in FIG. 14, the DCE may decide (e.g., only) that Data Set-1 may be to be (e.g., needs to be) recorded in the ADB-2.

As shown at 7 in FIG. 14, the DCE may (e.g., only) submit Data Set-1 to ADB-2 via BCN-2.

As shown at 8 in FIG. 14, BCN-2 may record Data Set-1 on ADB-2.

As shown at 9 in FIG. 14, BCN-2 may confirm with the DCE that Data Set-1 may be on-chain (e.g., now) in ADB-2.

As shown at 10 in FIG. 14, the DCE may convey coordination guidelines to DP-1 and DP-2, for example, for future data submission. For example, the DCE may indicate to DP-2 that its submitted data was not recorded by the blockchain due to the duplication with Data Set-1. The DCE may determine (e.g., find) that the data collected in Area-7 may be below a threshold (e.g., there may be not enough data being collected in Area-7). The DCE may suggest to DP-2 that it stay in Area-7 for data collection for a duration of time (e.g., in the next two hours if possible).

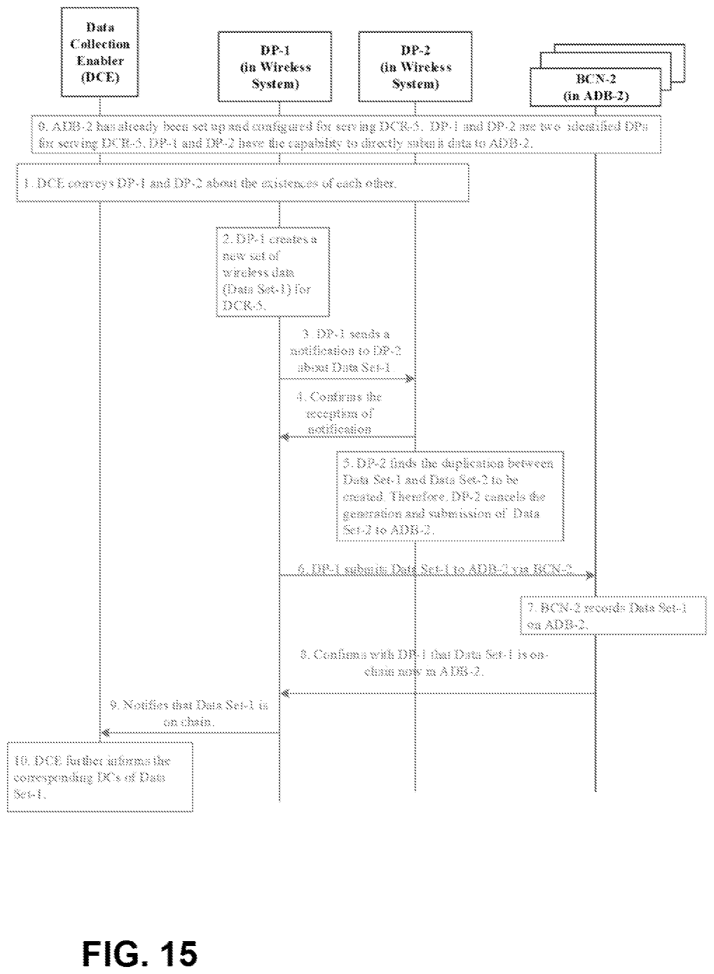

A second approach (e.g., Approach-2, which may enable direct coordination between DPs) may be performed, as shown in FIG. 15.

FIG. 15 illustrates an example data submission process with DP coordination (e.g., Approach-2: direct coordination between DPs).

As shown at 0 (e.g., Precondition) in FIG. 15, ADB-2 may be set up and configured (e.g., the system may already be set up and configured) for serving DCR-5. For example, DCR-5 may (e.g., be assumed to) collect historical cellphone signal strength in different areas of the Olympic Parks. DP-1 and DP-2 may (e.g., be assumed to) have the capability to directly submit data to ADB-2, and both of them may work diligently to generate requested data (e.g., because of certain incentives/rewards, etc.).

As shown at 1 in FIG. 15 (e.g., during the set-up stage), the DCE may convey the information (e.g., has already conveyed all the information) to DP-1 and DP-2 about how to submit collected data directly to ADB-2. The DCE may convey information to DP-1 and DP-2 regarding the existence of each other, for example, so that DP-1 and DP-2 may be able to communicate directly with each other.

As shown at 2 in FIG. 15, DP-1 may create a (e.g., new) set of wireless data (e.g., Data Set-1) for DCR-5.

As shown at 3 in FIG. 15, DP-1 may send a notification to DP-2 about Data Set-1. For example, the notification may carry metadata of Data Set-1. For example, the metadata may include one or more of the following: the DP ID of the creator of Data Set-1 (e.g., DP-1); the wireless data type (e.g., historical cellphone signal strength); the size of Data Set-1; the covered time period of Data Set-1 (e.g., in the last two hours); the mobility history of DP (e.g., Area-1 in the Olympic park); and/or the like. As shown at 4 in FIG. 15, DP-2 may confirm the reception of the notification.

As shown at 5 in FIG. 15, (e.g., based on the received metadata of Data Set-1) DP-2 may find the potential duplication between Data Set-1 and Data Set-2 to be created by itself. DP-2 may cancel the generation and submission of Data Set-2 to ADB-2. The overlapped/duplicated data sets may not be submitted to the blockchain system through this DP coordination. As shown at 6 in FIG. 15, DP-1 may submit Data Set-1 to ADB-2 via BCN-2.

As shown at 7 in FIG. 15, BCN-2 may record Data Set-1 on ADB-2.

As shown at 8 in FIG. 15, BCN-2 may confirm, with DP-1, that Data Set-1 may be on-chain (e.g., now) in ADB-2.

As shown at 9 in FIG. 15, DP-1 may notify the DCE that Data Set-1 may be on the chain in ADB-2.

As shown at 10, the DCE may inform the corresponding/potential DCs of Data Set-1. For example, those DCs may start to access Data Set-1 in ADB-2.

Data collection may be performed using a crowdsourcing-based information device (e.g., processor).

A (e.g., new) crowdsourcing-based information processor (CIP) mechanism may be used. Various terminals, devices, and/or WTRUs at the edge may have different capabilities and different computing/storage capacities. Those entities may act (e.g., potentially be acting) as CIPs for conducting the desired processing for the data (e.g., raw data) collected from DPs. For example, the desired processing may include one or more of the following: information extraction (e.g., conducting feature extraction from the collected raw images when doing machine learning training); format transformation; blockchain transaction creation; securely encoding the collected data; conducting data aggregation; conducting query processing over the data (e.g., raw data); and/or.

For example, those entities may be (e.g., just), 3rd-party entities. A smart contract may be used to incentivize the 3rd party entities, for example, to participate in the data collection process as CIPs, for example, with certain rewards. An (e.g., one single) entity may (e.g., only) have limited capability. For example, information processing may be conducted in a crowdsourcing-based approach, in which different CIPs may work collaboratively to process the data (e.g., raw data) collected from DPs.

Data collection may be performed using a single CIP.

The DCE may identify which entity may act as a CIP for conducting data processing of the data (e.g., raw data), for example, if (e.g., when) DPs have been identified for serving a DCR (e.g., DCR-1), the DCE may evaluate various entities and sign a smart contract with the desired entity (e.g., acting as the CIP-1). The CIP may provide information processing capability with the (e.g., expected) performance/quality (e.g., as described in the smart contract). The data (e.g., raw data) may be refrained from being (e.g., not be) submitted to the blockchain system by DPs. For example, the processed data may be submitted by the CIP to the blockchain system.

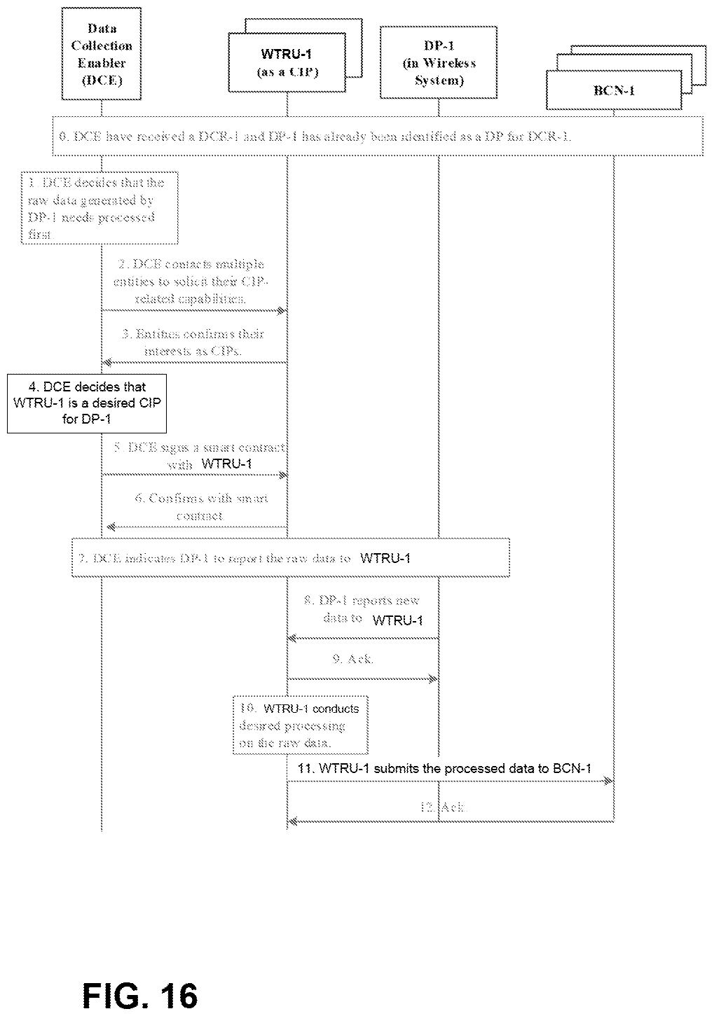

FIG. 16 illustrates an example of data collection with a CP (e.g., a single CIP).

As shown at 0 (e.g., Precondition) in FIG. 16, the DCE may receive a DCR-1 and DP-1 may be (e.g., has already been) identified as a DP for DCR-1 (e.g., using procedures as described herein).

As shown at 1 in FIG. 16, the DCE may decide that the data (e.g., raw data) collected from DP-1 may (e.g., need to) be preprocessed (e.g., first). For example, the DCs of DCR-1 may (e.g., intend to) obtain the cellphone signal quality for a particular WTRU (e.g., DP-1). The data (e.g., raw data) created by DP-1 may be wireless-related parameters, such as current wireless channel status, data loss rate, and/or the like. The DC of the DCR-1 may know (e.g., only need to know) whether the current signal quality may support a certain quality type of services, such as a high quality (e.g., may support HD video), medium (e.g., may support normal streaming, but not the HD), low (e.g., video streaming may not support).

As shown at 2 in FIG. 16, the DCE may contact multiple entities to solicit their CIP-related capabilities. For example, different WTRUs may move around or stay close to the DP-1. WTRUs may have certain computing capabilities for processing the data. The DCE may indicate the potential rewards for providing data processing help. The DCE may specify the details about how the data needs to be processed. One or more of the following information may be indicated (e.g., by the DCE). The information may indicate what type of data may be to be processed. Different types of data (e.g., raw data) may be collected from DPs (e.g., such as wireless-related data, mobility data, image data, or any other application-related data, etc.).

The information may indicate what kinds of processing may be used (e.g., needed), for example, different types of processing may be conducted (e.g., numerical data aggregation, data filtering, data format transformation, data assembly or composition, blockchain transaction creation, for example, if the DP does not have the capability to do so), machine learning related data (e.g., raw data) processing (e.g., feature extraction from the data (e.g., raw data), a query processing over the data (e.g., raw data)), etc.

The information may indicate what kinds of data processing module may be used (e.g., required). For example, depending on which kinds of processing are needed, it may need various process modules, and, if (e.g., a (e.g., only) numerical aggregation may be used (e.g., needed), (e.g., simple) code snippets for calculation may be used needed, (e.g., in some processes such as feature extraction for machine learning, a sophisticated feature extractor may be used (e.g., needed).

The information may indicate; what may be the output after processing which may indicate what the processed data looks like (e.g., the processed data may be submitted to the blockchain system).

The information may indicate how fast the data may (e.g., needs to) be processed, for example, which may (e.g., need to) be aligned with the requirements (e.g., as described in the corresponding DCR-1). For example, if the data may be short-living and uses (e.g., requires) a small data on-chaining delay, the data preprocessing may be performed (e.g., also needs to be done) in a quick manner.

The information may indicate how much data volume may be (e.g., needs to be) processed, for example, which may indicate the potential workload of the CIP (e.g., each candidate CIP may (e.g., need to) evaluate whether it may handle this workload). The information may indicate how long the data processing may (e.g., need to) be supported (e.g., the work schedule), for example, which may indicate how long the data processing may (e.g., need to) be provided (e.g., which may (e.g., need to) be aligned with the data collection schedule as indicated in DCR-1, for example, for the next three hours).

The information may indicate where to submit the processed data. For example, because (e.g., since) it may be the CIP to submit the data to the blockchain system (e.g., it may know (e.g., need to know) the blockchain access details.

The information may indicate how many rewards may be expected, for example, which may indicate how much reward may be expected by the CIP (e.g., as compared to the other items as described herein which may be data processing requirements). The information may be a combination of the above and/or the like. It may be possible that DCE itself (or the entity that hosts the DCE) has the requested capability as a desired CIP. In this case, the information processing may be conducted locally.

As shown at 3 in FIG. 16, different entities may confirm with DCE for their interests as CIPs.

As shown at 4 in FIG. 16, (e.g., based on the collected information) the DCE may decide that WTRU-1 (e.g., WTRU-1) may be the desired CIP for DP-1. For example, the selection of the desired CIP may be based on capabilities, performance, expected quality, proximity, cost, etc.

As shown at 5 in FIG. 16, the DCE may sign a smart contract with WTRU-1 (e.g., WTRU-1). For example, the smart contract may specify (e.g., all) the performance requirements (e.g., as described herein with respect to 2 in FIG. 16), and the expected details of the reward/incentive.

As shown at 6 in FIG. 16, the WTRU-1 (e.g., WTRU-1) may confirm the smart contract. WTRU-1 (e.g., WTRU-1) may configure (e.g., start to configure) its resources and set up a certain working instance. For example, the WTRU-1 (e.g., WTRU-1) may (e.g., need to) install a (e.g., new) software instance to perform data preprocessing. Such a data processing instance may be from the Internet, from other entities, and/or provided by DCs (e.g., if DCs have specific instructions related to how the data (e.g., raw data) shall be pre-processed, for example, where the detailed instruction may be included in the DCR-1 if/when the DC submits the DCR-1 to the DCE).

As shown at 7 in FIG. 16, the DCE may indicate to DP-1 to report data (e.g., raw data) to WTRU-1.

As shown at 8 in FIG. 16, DP-1 may report (e.g., new) data to WTRU-1. For example, this may be based on the details described in the DCR-1.

As shown at 9 in FIG. 16, WTRU-1 may confirm the data reception.

As shown at 10 in FIG. 16, WTRU-1 (e.g., as a CIP) may conduct processing on the data (e.g., raw data).

As shown at 11 in FIG. 16, the WTRU-1 may submit the processed data to BCN-1.

As shown at 12 in FIG. 16, BCN-1 may or may not confirm the reception of data. Data collection may be performed, for example, using a crowdsourcing-based CIP group.

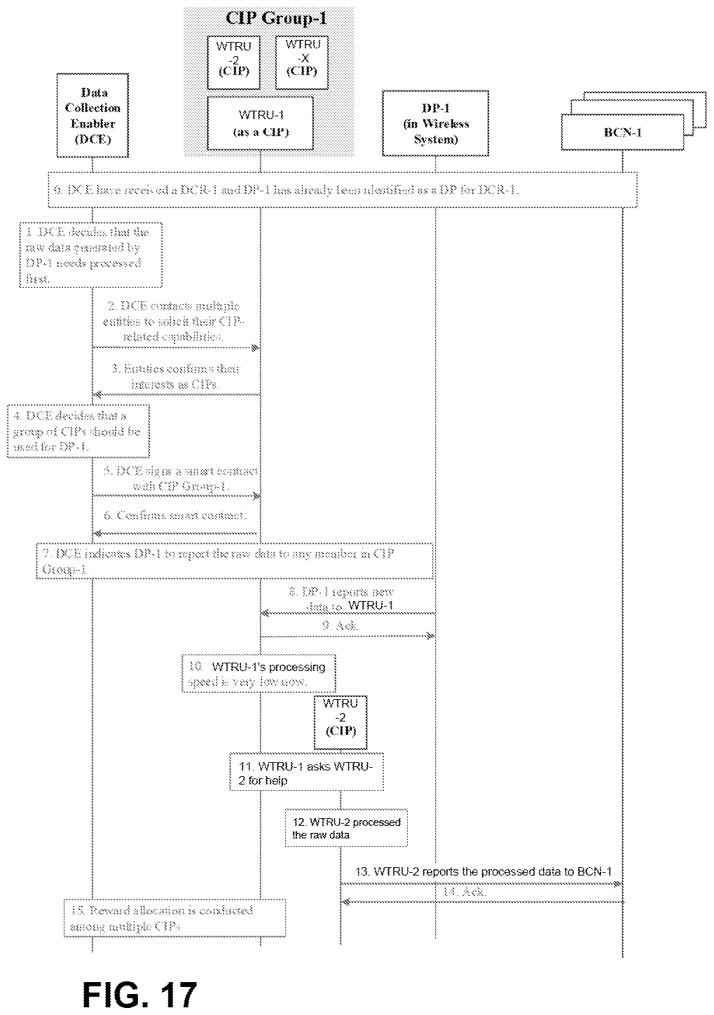

A (e.g., single CIP) may not be able to serve (e.g., all) the data preprocessing purposes and provide the desired performance, for example, if (e.g., when) relying on 3rd party for conducting the data processing. Data collection using a group of CIPs (e.g., as illustrated in FIG. 17) may be performed, for example, using one or more of the following procedures described herein.

FIG. 17 illustrates an example of data collection with a CIP group.

As shown at 0 (e.g., precondition) in FIG. 17, the DCE may have received a DCR-1 and DP-1 may have (e.g., already) been identified as a DP for DCR-1.

As shown at 1 in FIG. 17, the DCE may decide that the data (e.g., raw data) generated by DP-1 may (e.g., need to) be processed (e.g., first).

As shown at 2 in FIG. 17, the DCE may contact multiple entities to solicit their CIP-related capabilities. For example, different WTRUs may move around or stay close to the DP-1. WTRUs may have (e.g., certain) computing capabilities for processing the data. The DCE may indicate the potential rewards of being a CIP. The DCE may specify the details about how the data needs to be processed, and one or more of the following information may be indicated: what type of data may be to be processed; what kinds of processing may be used (e.g., needed); what kinds of data processing module may be used (e.g., required); what may be the output after processing; how fast the data may (e.g., need to) be processed; how much data volume may (e.g., need to) be processed; how long the data processing may (e.g., need to) be supported (e.g., the work schedule); where to submit the processed data; the blockchain access details; how many rewards may be expected; and/or the like.

As shown at 3, different entities may confirm their interests as CIPs.

As shown at 4, based on the collected information, DCE may decide that a CIP (e.g., a single CIP) may not be sufficient for conducting data processing for DP-1. DCE may decide that a group of CIPs may be used for processing the data (e.g., raw data) collected from DP-1. The following may be possible cases. For example, the processing of DP-1 may need several s, but no one particular CIP may complete one or more (e.g., all) the procedure. Multiple CIPs may be requested (e.g., needed). For example, related to machine learning feature extraction, a CIP may be equipped with a general-purpose feature extractor, which may process the data (e.g., raw data) fast with acceptable quality. In comparison, another CIP may be equipped with an application-specific feature extractor, which may yield high-quality results, but may take more time for processing.

As shown at 5 in FIG. 17, the DCE may sign a smart contract, for example, with a group of CIPs. For example, CIP Group-1 (WTRU-1 and WTRU-2 may be members of this group).

As shown at 6 in FIG. 17, the members of CIP Group-1 may confirm the smart contract.

As shown at 7 in FIG. 17, the DCE may indicate to DP-1 to report the data (e.g., raw data) to (e.g., any) members in the CIP Group-1.

As shown at 8 in FIG. 17, DP-1 may report the (e.g., new) data to WTRU-1.

As shown at 9 in FIG. 17, WTRU-1 (e.g., WTRU-1) may confirm the data reception.

As shown at 10 in FIG. 17, (e.g., due to the workload), WTRU-1 (e.g., WTRU-1, as a CIP group member) may determine (e.g., find) that (e.g., currently) its processing speed may be (e.g., very) low (e.g., below a threshold). By checking the tolerable data on-chaining delay, the WTRU-1 (e.g., WTRU-1) may know that the data collected from DP-1 may (e.g., need to) be processed (e.g., as quickly as possible). WTRU-1 (e.g., WTRU-1) may determine (e.g., conclude) that it may be unable to (e.g., may not) meet the requests and/or parameters (e.g., requirements), and it may (e.g., need to) ask other CIPs in the group for help.

As shown at 11 in FIG. 17, WTRU-1 (e.g., WTRU-1) may ask WTRU-2 (e.g., WTRU-2) for help along with the data received from DP-1.

As shown at 12 in FIG. 17, WTRU-2 (e.g., WTRU-2) may process the data (e.g., raw data), for example, based on the instructions described in the smart contract.

As shown at 13 in FIG. 17, WTRU-2 (e.g., WTRU-2) may report the processed data to BCN-1.

As shown at 14 in FIG. 17, BCN-1 may confirm the data reception.

As shown at 15 in FIG. 17, reward allocation may be conducted among multiple CIPs. For example, it may be based on their participation, contributions, etc.

Data collection may be performed with proactive wireless resource control.

The DCE may enable facilitating the data collection from DPs and may interact with the wireless system, for example, via APIs or interfaces (e.g., via NEF). The DCE (e.g., in examples of a system) may interact with the NEF network function, for example, to affect the operations of the system. A (e.g., new) data collection procedure may be performed with proactive wireless resource control. The DCE may contact the wireless system proactively, for example, so that the wireless system may provide stable/more wireless resources or connections for the (e.g., important) DPs for the data collection purpose. This may be useful, for example, if those DPs may not be treated as important/VIP entities inside the wireless system (e.g., DPs may be using ordinary wireless service subscriptions, such as, a personal wireless plan, etc.) and may not be able to obtain (e.g., more) wireless resources by themselves. For a non-VIP WTRU (e.g., from a system's perspective), the DCE may help the system to obtain more wireless resources, for example, if (e.g., from an application-level perspective) this WTRU may be an important DP for data collection. With the help of DCE, those important DPs may (e.g., always) be online so that the data collected from those DPs may be smooth. If (e.g., when) DPs become unavailable (e.g., because a DP loses its wireless connections, or a DP may be already not qualified for providing desired data), the DCE may try different approaches, for example, such as one or more of the following: the DCE may identify other alternative DPs to replace the original DPs; if the original DPs may not be replaced, the DCE may coordinate with the wireless system to make original DPs always be available by asking the wireless system to allocate more wireless resources to DPs; and/or the like.

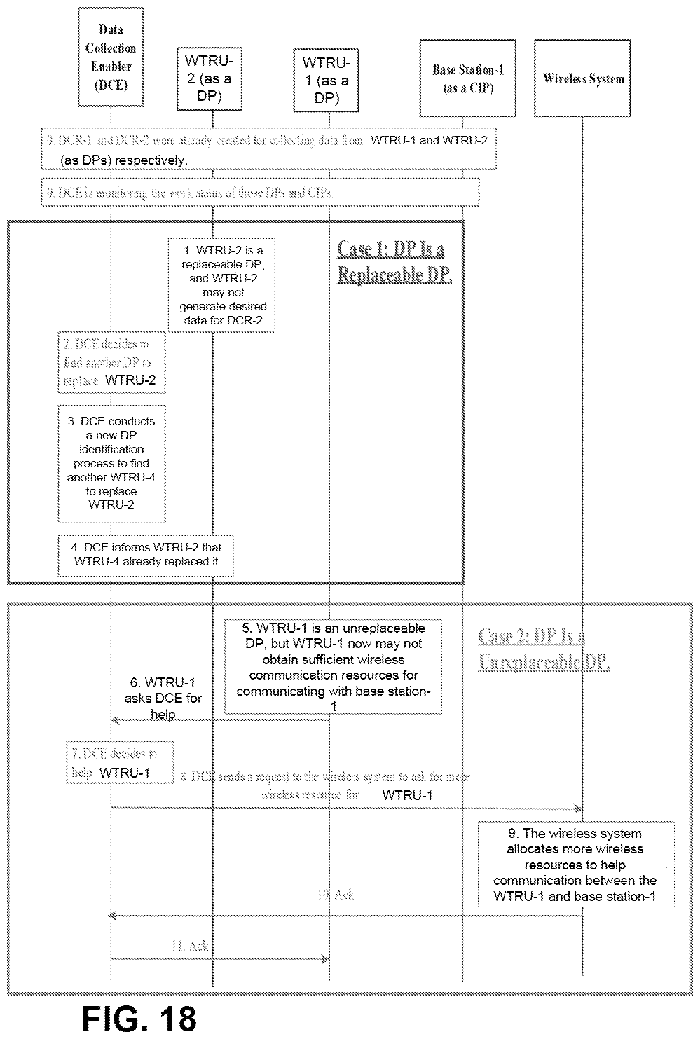

FIG. 18 illustrates an example of data collection with proactive wireless resource control.

As shown at 0 (e.g., Precondition) in FIG. 18, DCR-1 and DCR-2 may (e.g., already) have been created for collecting data from WTRU-1) and WTRU-2 respectively (e.g., as DPs). The data (e.g., raw data) generated by WTRU-1 may (e.g., need to) be processed by a CIP (e.g., first). A CIP may (e.g., be assumed to) be deployed on base station-1, for example, which may be the serving base station of WTRU-1. During the data collection stage, the DCE may monitor the work status of those DPs and CIPs. For example, the DPs may periodically report their working status to the DCE.

Multiple (e.g., two) types of DPs may be defined. A first type of DP may be a replaceable DP. For example, if (e.g., when) a DC (e.g., intends to) obtains images captured in a certain area, a (e.g., any) WTRU in this area may be a DP. For example, WTRU-2 (e.g., WTRU-2 for serving DCR-2) may (e.g., be assumed to) be a replaceable DP, for example, because (e.g., since) a (e.g., any other) DP in this area may provide the same function as WTRU-2 for serving DCR-1. A second type of DP may be an unreplaceable DP. For example, WTRU-1 may be the (e.g., only) qualified/available DP in a certain area, and there may be no other choice. WTRU-1 may be the targeted focus, for example, in the sense that the DCs (e.g., intend to) collect data from WTRU-1 itself.

In examples, a first scenario may include when DP may be a replaceable DP (as shown at 1-4 in FIG. 18).

As shown at 1 in FIG. 18, WTRU-2 may be a replaceable DP, and WTRU-2 may not be able to (e.g., may not) generate the desired data for DCR-2. Other reasons/conditions may also be possible for replacing WTRU-2, for example, including (e.g., but not limited to) one or more of the following: WTRU-2 may be running out of battery; WTRU-2 may be losing wireless connectivity frequently; WTRU-2 may not meet a parameter (e.g., may not meet a need); WTRU-2 may be overloaded; and/or the like.

As shown at 2 in FIG. 18, WTRU-2 (e.g., WTRU-2) may report its work status to DCE. DCE may decide to find another DP to replace WTRU-2 (e.g., WTRU-2).

As shown at 3 in FIG. 18, the DCE may conduct a (e.g., new) DP identification process (e.g., as described herein). The DCE may (e.g., be assumed to) find another WTRU-4 to replace WTRU-2. WTRU-4 may be omitted from FIG. 18 for simplicity.

As shown at 4 in FIG. 18, the DCE may inform WTRU-2 that WTRU-4 may have (e.g., already) replaced it. WTRU-4 may (e.g., start to) generate the desired data for DCR-2.

In examples, a second scenario may include when DP may be an unreplaceable DP (e.g., as shown at 5-11 in FIG. 18).

As shown at 5 in FIG. 18, WTRU-1 (e.g., WTRU-1) may be an unreplaceable DP. WTRU-1 may (e.g., now) not be able to (e.g., may not) obtain sufficient wireless communication resources for communicating with the base station-1 (e.g., which may be acting as a CIP).

As shown at 6 in FIG. 18, (e.g., from an application-layer perspective) DCR-1 may be a high-priority DCR. Data collection from WTRU-1 (e.g., WTRU-1) may be (e.g., very) important. WTRU-1 (e.g., WTRU-1, as a DP) may (e.g., from a wireless system perspective) not have a high-priority to get more wireless resources from the wireless system. WTRU-1 may be treated (e.g., from a wireless system perspective) as a regular WTRU (e.g., using an ordinary/personal wireless plan and does not have VIP privilege). WTRU-1 may not have a way to ask for more wireless resources. WTRU-1 may ask the DCE for help.

As shown at 7 in FIG. 18, the DCE may analyze the request and determine (e.g., find) that WTRU-1 may be an unreplaceable DP. The DCE may determine (e.g., find) that (e.g., from an application-level standpoint) data collection from WTRU-1 may be essential and may (e.g., need to) be supported in the best way possible.

As shown at 8 in FIG. 18, the DCE may send a request to the wireless system for help. For example, the DCE may contact and interact with various network functions (e.g., various NFs in the system via NEF, such as AMF, SMF, NWDAF, PCF, etc.).

As shown at 9 in FIG. 18, the wireless system may approve the DCE's request and may allocate more wireless resources to WTRU-1) to improve the communication quality between the WTRU-1 (e.g., WTRU-1 as a DP) and the CIP (e.g., base station-1). The DCE may be able to make sure that this extra amount of wireless resource may be used for DCR-1. WTRU-1 (e.g., WTRU-1) may be able to refrain from using (e.g., may not use) the extra wireless resources for other purposes. When DCR-1 may be complete, the DCE may be able to ask the wireless system to re-cycle the extra wireless resources allocated to WTRU-1 (e.g., WTRU-1).

As shown at 10 in FIG. 18, the wireless system may confirm with DCE that more wireless resources may have been allocated to WTRU-1.

As shown at 11 in FIG. 18, the DCE may confirm with WTRU-1 that more resources have been allocated to it.

The procedure (e.g., as described herein) may be described using a representative example (e.g., the wireless communication between a WTRU-1 and a base station-1) to illustrate how a DCE may interact with the wireless system to ask for more wireless resources. The proposed procedure may also be used for other scenarios: to ask more wireless resources to improve the communication between a CIP with a BCN, between CIPs, between DPs, between a DP and a CIP, between BCNs and DCs, between BCNs, between DCs, etc.

The DCE and blockchain system may be external to a system, or they may be integrated.

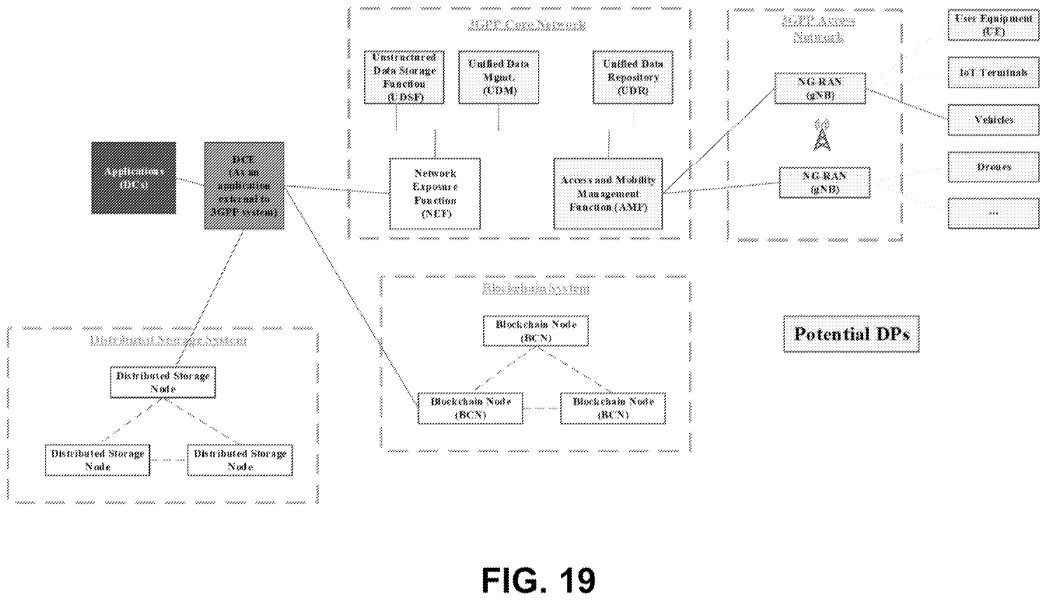

FIG. 19 illustrates an example procedure where the DCE and blockchain system may be external to a system.

As shown in FIG. 19, the proposed DCE may be embodied as an external application to the system. Applications acting as DCs may send their DCRs to DCE. In order to identify desired DPs inside the systems for collecting wireless-related data (e.g., which are created inside the system and not directly available/accessible by DCs), the DCE may interact with entities in the system (e.g., via the NEF). The (e.g., potential) DPs inside the system that may provide wireless-related data may include (e.g., but are not limited to) one or more of the following: (e.g., any) wireless data created by WTRUs, IoT devices, terminals, vehicles, drones, or other terminals; wireless data generated by entities (e.g., in NG-RAN), for example, including gNB base stations, various NFs in the core network (e.g., e.g., AMF, UDM, UDR, UDSF, NWDAF, etc.), and the OAM system. The blockchain system may be external to the system. Other distributed storage systems may be used for wireless data sharing (e.g., using implementations and/or procedures as described herein). The interactions (e.g., the proposed services, parameters, requests/responses) with the blockchain system may be used to interact with other types of distributed storage systems.

The DCE may be an AF, and the blockchain system may be supported by a (e.g., new) NF.

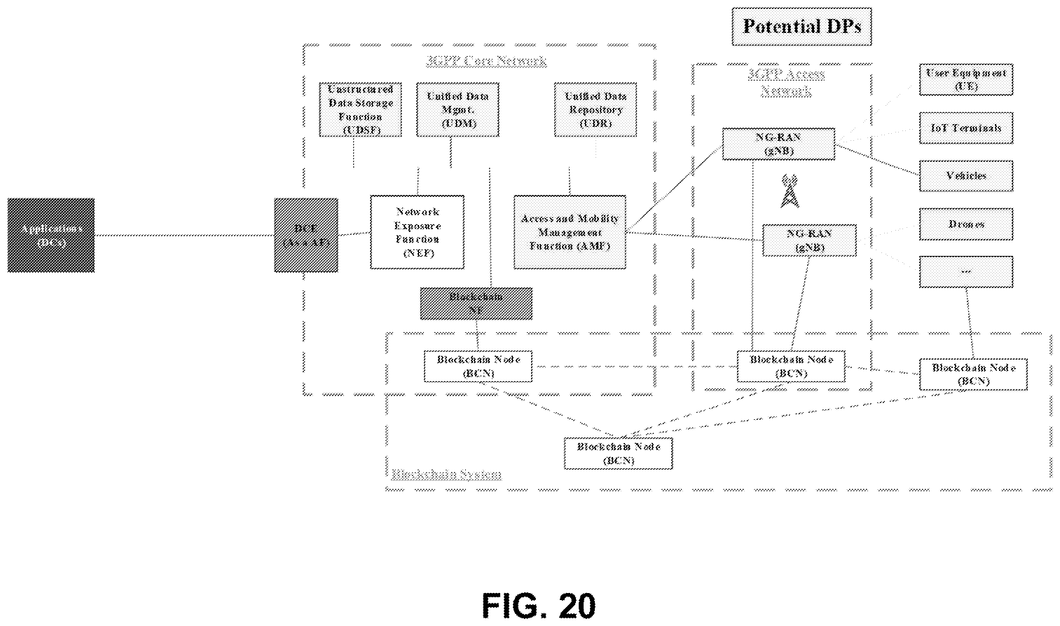

FIG. 20 illustrates an example procedure where a blockchain system may be used.

As shown in FIG. 20, blockchain technology may be leveraged. The procedure used as shown in FIG. 20 may include parts similar to the procedure as shown in FIG. 19. The blockchain node may be deployed directly inside the system (e.g., in contrast to the procedure in FIG. 19). Different deployment choices may be used, for example, such as a BCN node may be deployed in the core network of the system for serving data collection needs for the control plane. For example, if the various NFs (e.g., such as AMF, SMF) are the desired DPs, they may submit their data to the BCN available in the core network. A BCN may be deployed co-located with a gNB (e.g., in the NG-RAN) such that gNB or WTRUs may directly submit their data to the BCN in proximity (e.g., or at the edge). A UPF may be deployed in the access network, for example, which may steer the data submission traffic to a BCN deployed in a local area data network (LADN). A (e.g., new) blockchain NF may be defined in the core network, for example, for providing blockchain-related service (e.g., or it may be an extended function of an existing NF, such as UDR/UDSF/NRF/Etc.). The DCE may be an AF inside the trust domain of the system or outside the trust domain of the system.

The DPs inside the systems may be able to directly interact with the blockchain system (e.g., via the blockchain NF). For example, an AMF (e.g., as a DP) may report a piece of collected wireless data and submit it to a BCN deployed in the core network via the blockchain NF. In some examples, a WTRU or a gNB (e.g., as DPs) may submit their data to another BCN deployed in the access network.

For example, the event exposure via NEF and a data collection process may be leveraged for the DP identification purpose. For example, different NFs or Afs in the core network may provide various data. Based on any (e.g., new) type of data that may be provided by a given NF or AF, it may generate event exposures with (e.g., new) EventIDs to be associated with the (e.g., new) type of data. The DPs may leverage NRF to publish the new type of wireless data by invoking Nnrf_NFManagement_NFUpdate_request service operation. Those Event IDs may be available for discovery. The DCE may ask NEF to invoke Nnrf_NFDiscovery_Request_request service operation sent to NRF, for example, to identify the desired event IDs.

The event exposure service from NF(s) may include one or more of the following parameters (e.g., if/when initiating a data collection request): event-IDs, target of event reporting, event filter information, event reporting information, expiry time, a combination thereof, and/or the like.

These different events may realize the proposed DCR (e.g., as described herein). For example, (e.g., based on the kind of wireless data that may (e.g., need to) be collected as specified in a DCR), it may be mapped to a number of events to be monitored/reported. Types of wireless data may not be defined as event types. Different (e.g., new) event data types may be added/defined.

Event subscription service operations provided by different NFs (e.g., such as AMF, UDM, etc.) may be leveraged, for example, to set up data collection from a given DP. For example, a procedure may be used by NWDAF to subscribe/unsubscribe to various NFs to collect data from those NFs, which may be used by DCE to set up a DP data collection task (e.g., as described herein).

In case DPs (e.g., need to) directly interact with a BCN, (e.g., new) parameters (e.g., how to submit data to a BCN, based on what blockchain transaction format, the decided BCN scheduling, etc.) may be provided and/or used (e.g., needed). For example, if (e.g., when) the blockchain service may be a (e.g., new) NF, the DCE may indicate to DPs how to report the collected events to the blockchain service NF (e.g., if/when the DCE sends the Nnf_EventExposure_Subscribe command to a particular NF (e.g., as a DP). DPs may submit their data to a UDSF that may be shared with the BCN, for example, instead of submitting their data directly to the BCN. The BCN may receive a notification, for example, if (e.g., when) data may be written to the UDSF by a DP.

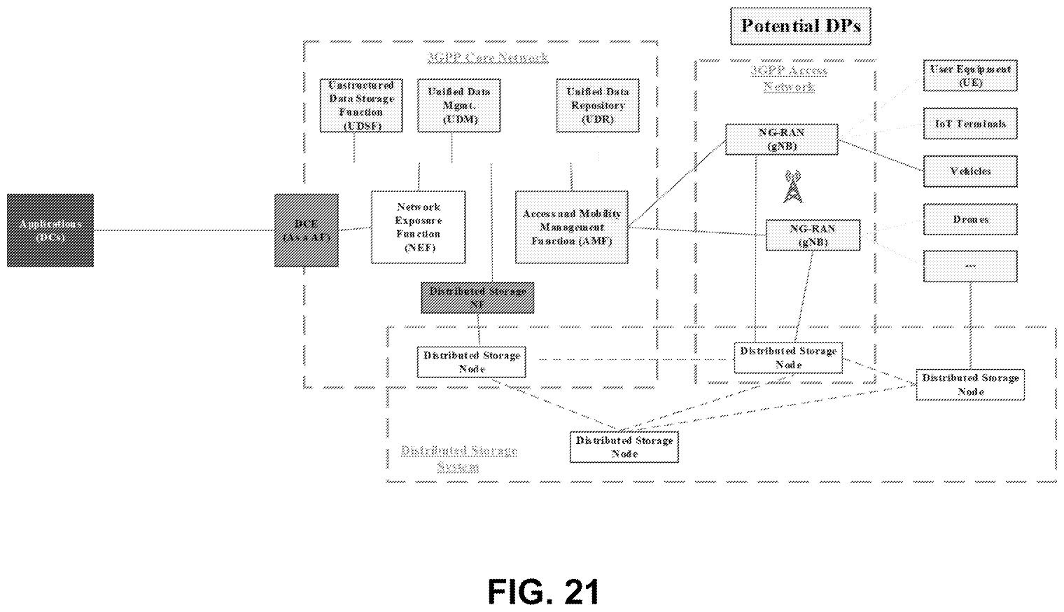

FIG. 21 illustrates an example procedure associated with using a distributed storage system. In examples (e.g., as shown in FIG. 21), the blockchain may be refrained from being used (e.g., not used). Other types of distributed storage systems may be adopted. A (e.g., new) distributed storage NF may be used (e.g., for this purpose).

A service flow procedure for customized blockchain setup and configuration procedure(s) (e.g., with respect to FIG. 7), may be performed and/or provided, for example, based on procedures and/or implementations (e.g., as shown in FIG. 20).

This service flow may refer to the customized blockchain setup and configuration stage (e.g., as illustrated in FIG. 7.

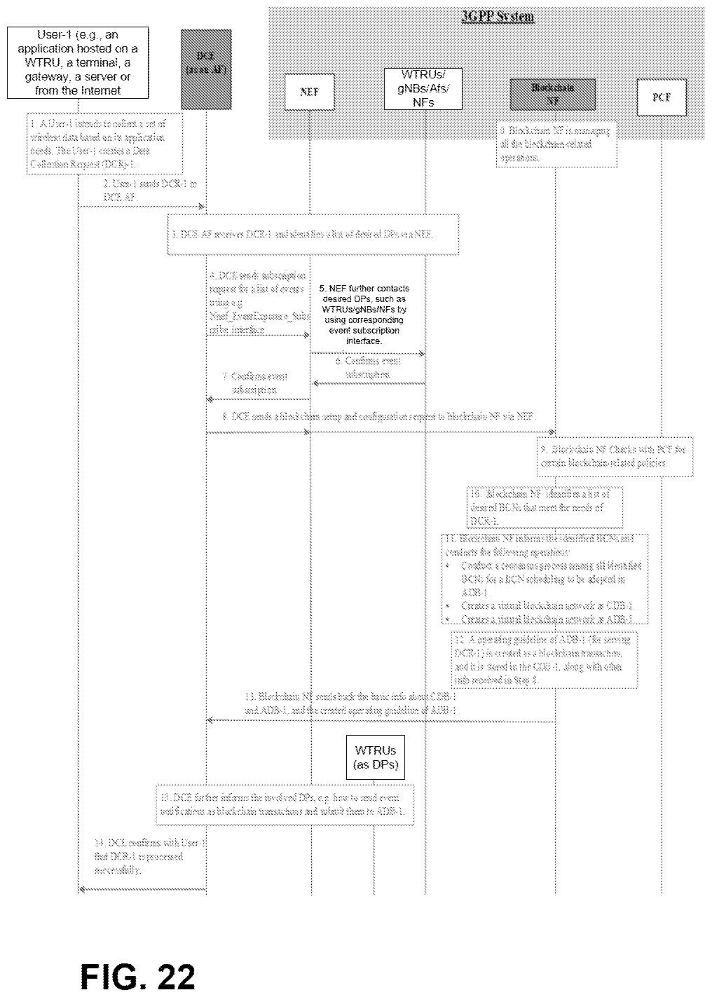

FIG. 22 illustrates an example service flow procedure for a customized blockchain setup and configuration procedure.

Procedures may be WTRU-involved (e.g., running various phone applications). WTRUs' communication capability/performance may be supported by the underlying communication infrastructure (e.g., such as Wi-Fi, 3GPP cellular system, etc.). The wireless-related data (e.g., current signal strength, data rates, allocated channel bandwidth) generated by the underlying communication infrastructure may be useful for the upper-layer application to conduct application-specific operation optimizations, for example, if (e.g., when) WTRUs are using a cellular system. Blockchain may be a preferred intermediate storage medium to store the collected data, for example, because the blockchain may have advantages for supporting data sharing between untrusted entities, providing data tamper-proof support (e.g., so that data may not be tampered with during the collection process), supporting traceability (hard-record data circulation history), high-availability (not having a single-point-failure risk), fully-flexile data sharing (e.g., one-to-one sharing, one-to-many sharing, many-to-one sharing, many-to-many sharing) with lower overhead (e.g., without overloading the wireless system for repetitive data collection), and native incentivization mechanism with automatic rewards allocation. If (e.g., when) submitting data into the blockchain, the blockchain internal processing may take a certain time cost before data becomes available/accessible (e.g., leading to certain data on-chaining delay). Wireless data (e.g., especially for the real-time context data) may be short-lived. The blockchain processing may (e.g., shall) be conducted with minimum delay. Customized blockchain processing may support application-need-aware data collection (e.g., requiring minimum data on-chaining delay).

Pre-conditions may be provided and/or used. One or more of the following pre-conditions may be used (e.g., assumed), for example, in FIG. 22.

A DCE may act as an AF, which may support wireless data collection as blockchain technology. The DCE (e.g., as described herein) may be embodied as an AF. The DCE may be an application-layer software deployed in various terminals, for example, such as WTRUs, gateways, servers, etc.

Service flows may be provided and/or used. FIG. 22 may be related to the procedure, as shown in FIG. 7.

As shown at 1 and 2, the procedure in FIG. 22 may be the same as at 1 and 2 in FIG. 7, respectively.

As shown at 3 in FIG. 22 (e.g., similar to 3 of FIG. 7) the DCE AF may contact the NEF, for example, to conduct discovery operations at the UDM/UDR and NRF. Through the discovery, the DCE may identify a list of desired DPs. For example, the embodiment of DPs may include one or more of the following: WTRUs, (e.g., NG-RAN) nodes or gNBs, NFs, for example, such as AMF, SMF, LMF, etc., other Afs, etc.

As shown at 4 in FIG. 22 (e.g., similar to 4 of FIG. 7) the DCE may collect data from certain NFs. The DCE may use the event exposure capability of NEF to collect data. The DCE may send a subscription request for a list of interested events (e.g., defined by certain Event IDs), for example, using an Nnef_EventExposure_Subscribe interface. If DCE AF may be a trusted AF, it may directly collect data from various NFs.

As shown at 5 in FIG. 22, the NEF may contact desired DPs. For example, the NEF may use interact with existing NFs (e.g., AMF/SMF/etc.) by using the corresponding event subscription interface. In the case where DPs are WTRUs/gNB, the NEF may interact with their corresponding AMFs, for example, to set up certain event subscriptions.

As shown at 6 in FIG. 22, the desired DPs may confirm NEF with successful event subscriptions.

As shown at 7 in FIG. 22, the NEF may confirm DCE with successful event subscriptions.

As shown at 8 in FIG. 22 (e.g., similar to 7 of FIG. 7), the DCE may send a blockchain setup and configuration request to the blockchain NF (e.g., via NEF). It may be (e.g., assumed) that a (e.g., new) blockchain configuration service may be defined for the NEF (e.g., a Nnef_blockchain_setup service operation may be added as a new service operation), or a (e.g., new) blockchain NF may be defined in the core network (e.g., which manages all the underlying blockchain nodes and may conduct customized blockchain setup and configuration depending on the application needs).

As shown at 9 in FIG. 22, a (e.g., 5G) system may define a dedicated Policy Control Function (PCF), for example, to provide a variety of functionalities for policy control. A PCF may be responsible for provisioning different policies to control plane functions (e.g., AMF, SMF, NEF), WTRU, and AF, for example, where the provisioned policies may be installed and enforced. Certain blockchain-related policies may be stored in the PCF. The blockchain NF may check with the PCF for blockchain-related policies, for example, such as which BCNs may not be the candidate BCNs for serving DCR-1, etc.

As shown at 10 in FIG. 22, the procedure may be the same as at 8 of FIG. 7.

As shown at 11 in FIG. 22, the procedure may be the same as the procedure at 9 of FIG. 7. Blockchain NF may use identified BCNs to create ADB-1 and CDB-1 for DCR-1.

As shown at 12 in FIG. 22, the procedure may be the same as that at 10 of FIG. 7.

As shown at 13 in FIG. 22, the procedure may be the same as at 11 of FIG. 7. The DCE may update the notification address(es) that are associated with the subscriptions (e.g., that were configured at 4). The notification addresses(es) that are provided to the NEF may be an address (e.g., URI) of the blockchain NF so that the data may be sent directly to the blockchain by the NEF or by the DP.

As shown at 14 in FIG. 22, the procedure may consider the use case where the DPs may directly submit their data to the blockchain system. The DCE may (e.g., need to) interact with NEF, for example, in order to configure the involved DPs (e.g., such as AMF/SMF/UEs/gNBs) such that when a specific event happens, the event notifications may be realized as blockchain transactions and submitted to ADB-1. The DCE may (e.g., need to) convey (e.g., other useful) information to the DPs, for example, regarding the data sampling rates, covered time period, and minimum data on-chaining delay requirement as described in DCR-1.

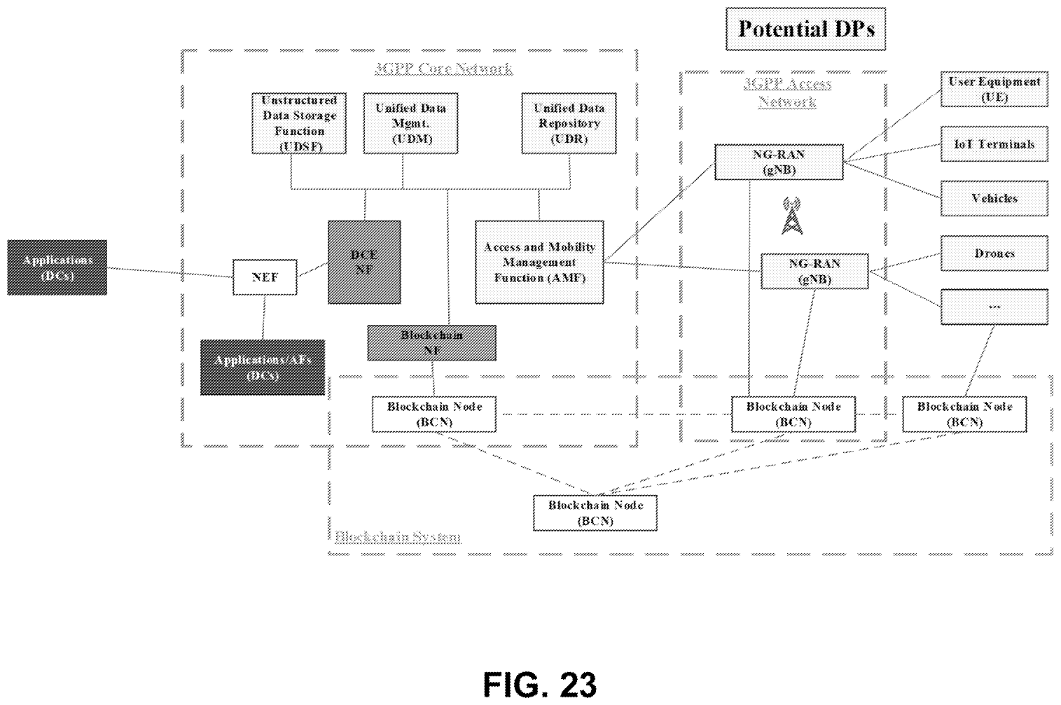

As shown at 15 in FIG. 22, the DCE may confirm with User-1 that DCR-1 may be processed successfully. Post-conditions may be provided and/or used, for example, in the procedure as shown in FIG. 23. The post-conditions may be one or more of the following: a data collection request (e.g., DCR-1) initiated by User-1 may be successfully processed by DCE; a customized blockchain may be set up and configured for serving DCR-1; the involved DPs in the system start to submit their data as blockchain transactions to the desired blockchain nodes in the customized blockchain system; the customized blockchain system processing may meet (e.g., fully meet) the requirements of DCR-1; the User-1 (e.g., as a DC) may access the collected data once they are successfully recorded by the blockchain system; etc.

The existing event exposure (e.g., via NEF) and the data collection process may be re-used for the DP identification purpose. Some blockchain-related functions/services/operations may not be (e.g., currently) specified/defined.

Potential (e.g., new) requirements may be used (e.g., needed) to support the use case.

The procedure as described in FIG. 22 may be used, for example to accomplish one or more of the following: the system may support distributed data storage (e.g., such as blockchain system) for wireless data collection and sharing for serving upper-layer application entities; the system may provide a blockchain service that may set up a (e.g., new) blockchain network, for example, if there may be no existing/available blockchain network that may be utilized for storing the collected wireless data; the system may provide a blockchain service that may customize the processing of the created blockchain network, for example, to meet the application-specific data collection/sharing needs (e.g., having minimum data on-chaining delay); etc.

The procedure (e.g., as described in FIG. 22) may also be tailored or simplified. For example, in a basic version, it may (e.g., only) support an (e.g., one) use, or in an enhanced version, it may support multiple (e.g., both) uses.

Both DCE and blockchain may be (e.g., new) NFs. FIG. 23 illustrates an example procedure where the DCE and blockchain may be network functions (NFs).

As shown in FIG. 23, the procedure may be similar to the procedure as shown in FIG. 20. A difference from the procedure as shown in FIG. 20 may be that the proposed DCE may be realized as a (e.g., new) NF in the core network. Potential DCs may directly come from the system or come from external systems, such as third-party applications. The DCs may interact with the DCE NF, for example, via the NEF. The procedure as described in FIG. 23 may correspond to a (e.g., pure) SA2 implementation for the proposed DCE (e.g., as described herein).

As shown in FIG. 23, (e.g., similar to the procedure in FIG. 21) the blockchain system may not be used. For example, other types of the distributed storage system may be adopted for wireless data sharing.

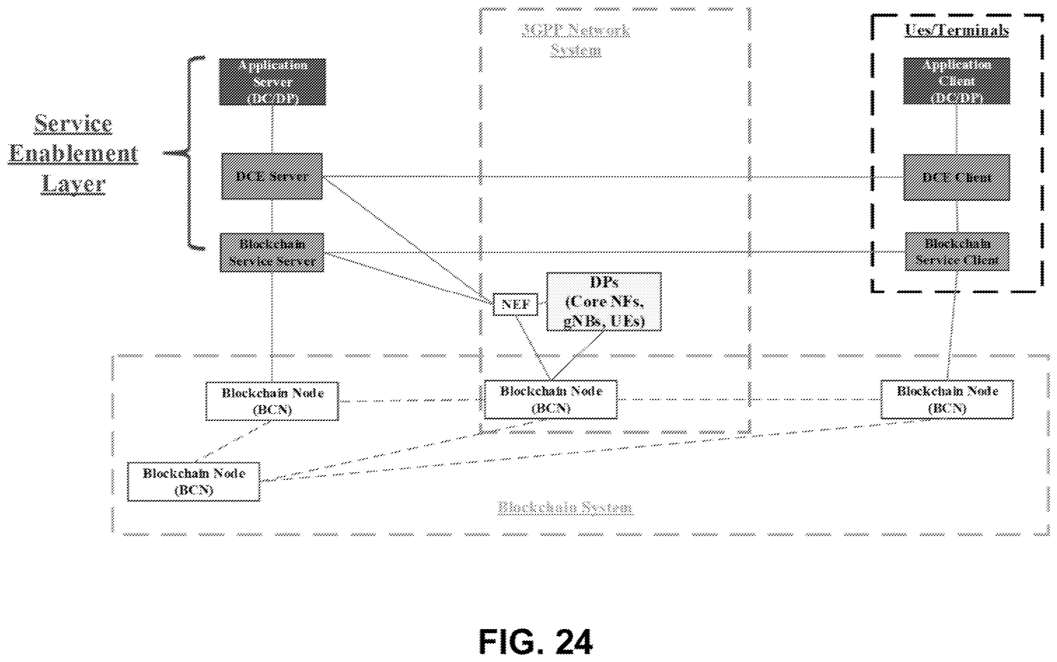

FIG. 24 illustrates an example procedure that uses a blockchain system in a layer, such as the SA6 service enablement layer.

As shown in FIG. 24, the proposed DCE may be realized on top of the system. For example, one or more (e.g., two) services (e.g., new services) such as DCE service and blockchain service may be (e.g., new) services in the SA6 service enablement layer. The DCE service may be implemented as a DCE server and a DCE client (e.g., hosted on WTRUs). The blockchain service may be implemented as a blockchain server and a blockchain client (e.g., hosted on WTRUs). The DCs and DPs may come from the server-side and the client-side as well. In examples (e.g., the Olympic Park example), the application client may be the live webcast App (e.g., as a DC) hosted on network anchor's WTRU. For example, the live webcast application server may be deployed in the cloud (e.g., as another DC). Both live webcast Apps on the WTRU and the application server may be DPs, for example, if application-specific data may (e.g., need to) be collected. The live webcast App and its application server may use (e.g., need) certain wireless data to be collected. For example, an application client may send a DCR to the DCE client, which may further contact the DCE server to identify the DPs for this DCR. The DCE server may interact with the underlying system (e.g., via NEF) to identify qualified DPs inside the system. For example, BCNs may be deployed outside the underlying system or may be deployed directly inside the system (e.g., a BCN node may also be directly hosted by a mobile terminal such as WTRU). The procedures described herein may apply to the other procedures (e.g., as described herein). For example, the DCE server may interact with those BCNs via the blockchain service server. The DCE server may also be embodied as the Edge Enabler Server (EES) and the DCE client may also be embodied as the Edge Enabler Client (EEC) as proposed in the EdgeApp architecture, for example, if EES and EEC may implement certain DCE-related functions.

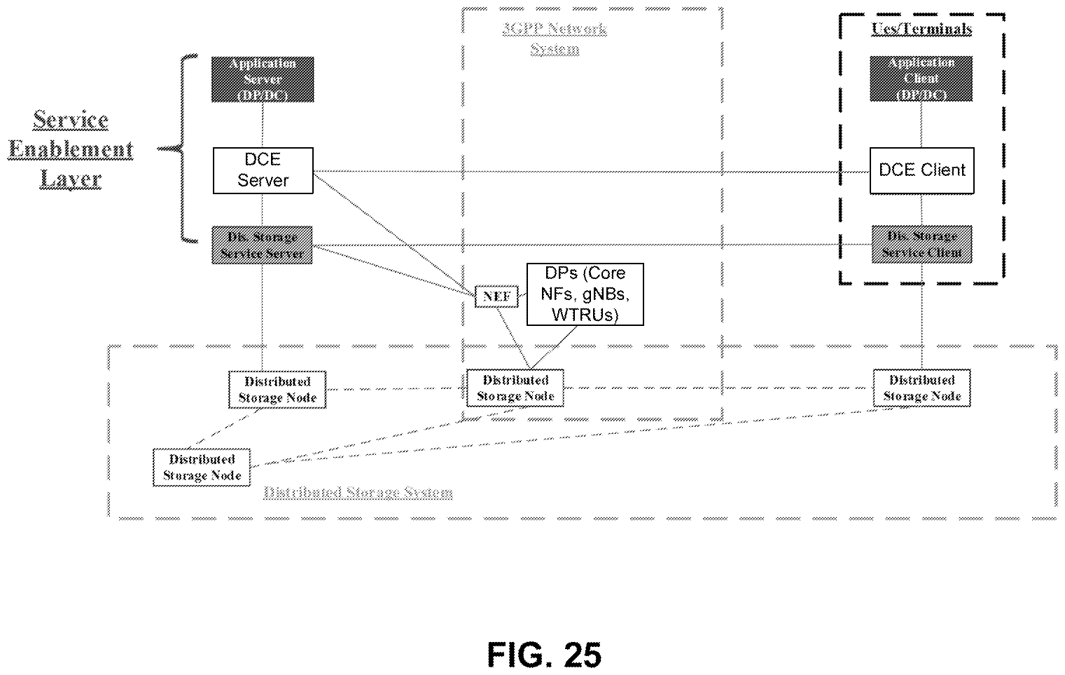

Other types of distributed storage systems may also be adopted. For example, the distributed storage service may be implemented as a distributed storage server and a distributed storage client, which may be hosted on WTRUs, as shown in FIG. 25.

FIG. 25 illustrates an example procedure using one or more distributed storage system(s).

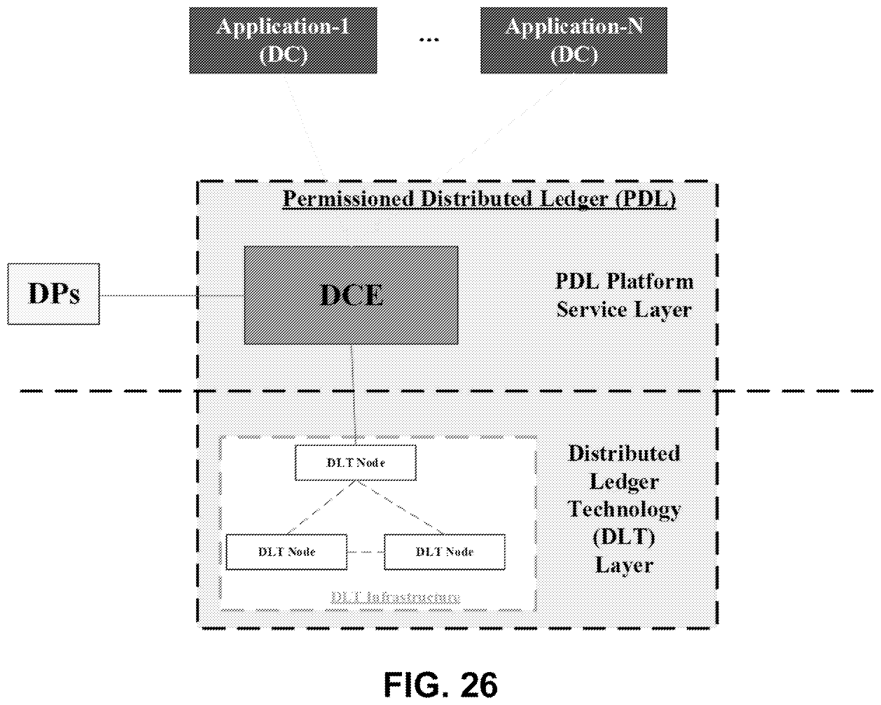

FIG. 26 illustrates an example PDL procedure. As shown in FIG. 26, the applications may be the users of PDL systems, and they may be (e.g., potential) DCs. The DCE may be a (e.g., new) platform service in the PDL platform service layer. The DCE platform service may interact with the distributed ledger technology (DLT) layer (e.g., in which the DLT infrastructure resides). The blockchain network and blockchain node may be replaced with more generalized entities, for example, such as the distributed ledger and the DLT nodes.

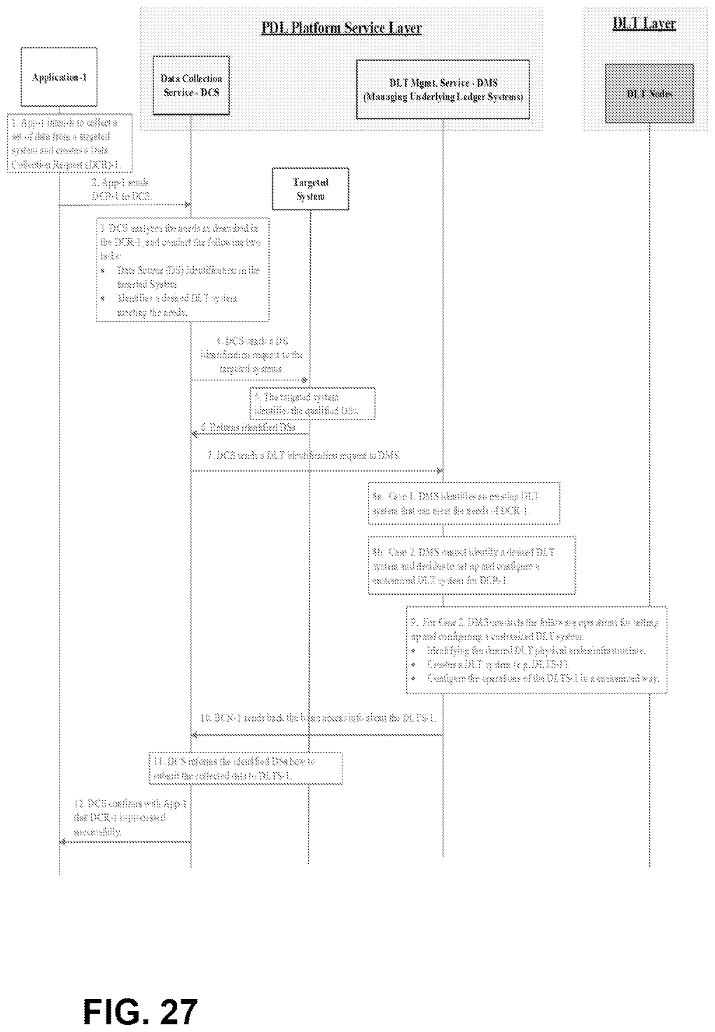

FIG. 27 illustrates an example PDL procedure. FIG. 27 shows a first PDL embodiment for the procedure as proposed in FIG. 7. The involved entities may have the following embodiment in the ETSI PDL: DCE may be embodied as a Data Collection Service (DCS) in PDL; DP may be embodied as a Data Source (DS) in PDL; DCE Client/User may be embodied as a distributed application in PDL; and a wireless system may be embodied as a targeted system in PDL.

As shown at 1 in FIG. 27, App-1 may intend to collect a set of data from a targeted system and may create a Data Collection Request (DCR)-1. The DCR-1 may specify one or more the details regarding its needs. For example, DCR-1 may specify one or more of the following: what type of data may be to be collected; from which targeted system. The targeted system may be any application-specific systems. For example, the targeted system may be a wireless system (e.g., any network), a transportation system (e.g., when collecting smart city-related data), a supply-chain system (e.g., when collecting supply-chain related data), a factory system (e.g., when collecting production line data in a smart factory), etc. DCR-1 may specify a DS selection criteria. The DS selection criteria may specify how to identify the desired DSs. DCR-1 may specify a covered time period. The covered time period may indicate the preferred time period for collecting the desired data from the DSs. DCR-1 may specify DLT-related requirements. The DLT-related requirements may indicate the desired type of DLT system for storing the collected data. For example, if collecting data from a wireless system, the real-time channel status or signal strengths of smartphones may be short-lived and a (e.g., only) valid for a limited time. If the collected wireless data may be uploaded to a DLT system, it may need to have a minimum processing delay using a low-latency consensus protocol so that the data may become available for sharing with others in the shortest time interval.

As shown at 2 in FIG. 27, App-1 may send DCR-1 to DCS. DCS may be a data collection enabler in the PDL platform service layer.

As shown at 3 in FIG. 27, DCS may analyze the needs (e.g., as described in the DCR-1), and may conduct one or more of the following tasks: Data Source (DS) Identification in the targeted system (e.g., as described at 4-7 in FIG. 27), for example, which may be used to find qualified DSs for DCR-1; identify the desired DLT system meeting the needs (e.g., as described at 8-12 in FIG. 27), for example, to find an underlying DLT system that may meet the DLT-related requirements; etc.

As shown at 4 in FIG. 27, the DCS may send a DS identification request to the targeted systems. For example, the DCS may interact with a system to identify the qualified DSs (e.g., such as smartphones, base stations, etc.).

As shown at 5 in FIG. 27, the targeted system may identify the qualified DSs, for example, based on the DS selection criteria.

As shown at 6 in FIG. 27, the targeted system may return identified DSs to the DCS.

As shown at 7 in FIG. 27, the DCS may send a DLT identification request to DLT Management Service (DMS). DMS may be a service in the PDL platform service layer, and may have the (e.g., full) capability to conduct (e.g., all) the management activities of the underlying DLT system.

As shown at 8a in FIG. 27, in a first scenario, the DMS may identify a (e.g., existing) DLT system that may meet the needs of DCR-1. If the DMS identifies a DLT system (e.g., DLT system currently operating) that may meet the needs of DCR-1, the procedure at 10 may be followed in FIG. 27.

As shown at 8b in FIG. 27, in a second scenario, the DMS may be unable to (e.g., may not) identify the desired DLT system and may decide to set up and configure a (e.g., new) customized DLT system for DCR-1. If the DMS is unable to (e.g., may not) identify the desired DLT system, the procedure at 9 may be followed in FIG. 27.

As shown at 9 in FIG. 27 (e.g., if the DMS identifies a DLT system that may meet the needs of DCR-1), the DMS may conduct one or more of the following operations for setting up and configuring a customized DLT system: identifying the desired DLT physical nodes/infrastructure, for example, the DMS may select a batch of DLT nodes for creating a customized DLT system; based on the selected DLT physical nodes, create a DLT system (e.g., DLTS-1), for example, using a first approach, a (e.g., new) physical DLT system may be set up using the selected DLT nodes, or a second approach, virtualization technology may be leveraged, for example, a virtualized DLT system slice may be created on top of the selected DLT nodes, and a (e.g., each) physical DLT may potentially operate multiple virtualized DLT system/network slices; configure the operations of the DLTS-1 in a customized way, for example, in order to achieve minimum processing delay for recording the collected real-time data in the ledger, the consensus protocol component may (e.g., shall) be configured (e.g., by adopting an existing consensus protocol that may meet the delay constraint or adopt (e.g., any new or) customized consensus protocol if needed (e.g., using procedures as described herein). The process shown at 9 in FIG. 27 (e.g., adopting an existing consensus protocol or adopting a customized consensus protocol) may apply to the process at 9 in FIG. 7.

As shown at 10 in FIG. 27, the BCN-1 may respond with the basic access information about the identified/created DLT system for DCR-1 (e.g., DLTS-1).

As shown at 11 in FIG. 27, the DCS may inform the identified DSs on how to submit the collected data to DLTS-1. If (e.g., when) the data collection starts, the DSs may include their data in ledger transactions and may submit it to DLTS-1.

As shown at 12 in FIG. 27, the DCS may confirm with App-1 that DCR-1 has been processed successfully.

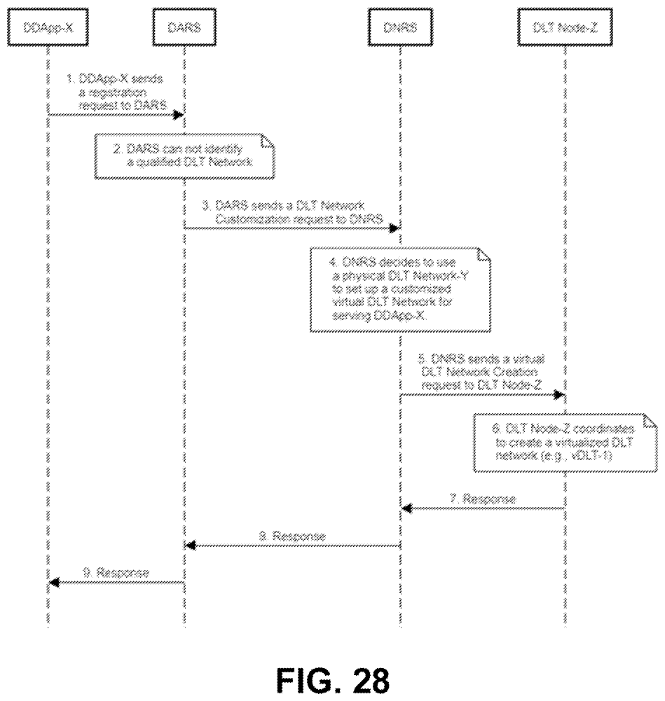

FIG. 28 shows another example PDL procedure. For example, FIG. 28 may show a second PDL embodiment for the procedure that may be similar to the procedure shown with respect to FIG. 7. Referring again to FIG. 28, in an embodiment, the proposed DCE may also be extended for helping a Distributed Application-X (DDApp-X) to find or configure/customize a desired DLT network (e.g., when the DDApp-X registers itself to the PDL system). In an embodiment, the proposed DCE may not support data collection requests, but may help a registered DDApp-X to find/configure a desired DLT network. The involved entities may have the following embodiment in the PDL: the DCE may be the DTL Network Registration Service (DNRS) in PDL; the DCE Client/User may be the distributed application in PDL (e.g., DDApp-X); and/or the DTL Application Registration Service (DARS).

When a DDApp-X registers with the DARS, the DARS may interact with DNRS to assign a registered DLT network that may meet the requests (e.g., requirements) for the DDApp-X (e.g., a desired consensus protocol, desired DLT performance requirements, specific desired transaction format, and/or the like). In an embodiment, when a DLT Network-Z registers to the DNRS, it may indicate to DNRS whether it supports DLT virtualization technology, through which multiple virtual DLT networks (e.g., having independent/respective operating characteristics) may be dynamically set up and configured over the DLT Network-Z (e.g., same physical DLT Network-Z). When there may not be a qualified DLT network registered to DNRS to meet the request (e.g., requirements) of the DDApp-X, the DNRS may leverage the physical DLT Network-Z to dynamically configure a customized Virtualized DLT Network (or vDLT-1) meeting DDApp-X's requests and/or parameters (e.g., requirements). Using the DNRS to customize a DLT network for serving a distributed data application, DDApp-X may include one or more of the following, as shown in FIG. 28.

At 1, a DDApp-X may send a registration request to DARS to use the services provided by the ETSI-ISG-PDL platform. Through the registration request, the DDApp-X may specify its DLT requests and/or parameters (e.g., requirements, which may include a desired consensus mechanism, desired DLT performance requirements, etc.).

At 2, DARS may not identify a qualified DLT Network from the DLT network repository, which stores registered DLT networks that have registered to the DNRS.

At 3, DARS may send a DLT Network Customization request to DNRS, along with the DLT requests and/or parameters (e.g., requirements) of the DDApp-X.

At 4, the DNRS may identify that the registered DLT Network-Y may support the DLT virtualization technology. The DNRS may decide to use the physical DLT Network-Y to set up a customized virtual DLT Network for serving DDApp-X.

At 5, DNRS may send a virtual DLT Network Creation request to DLT Node-Z (e.g., the manager or controller node of the physical DLT Network-Y). This request may include the customized DLT operation parameters. The parameters may include one or more of the following: the number of virtual DLT nodes, a specific consensus protocol desired by the DDApp-X, customized transaction format desired by the DDApp-X, and/or customized block size desired by the DDApp-X.

At 6, DLT Node-Z may record the received DLT operation parameters (e.g., in the ledger of the physical DLT network-Y or in another DLT Network). The DLT Node-Z may instruct the participating DLT Nodes of the physical DLT Network-Y to set up a virtualized DLT network (e.g., vDLT-1) according to these DLT operation parameters.

At 7, DLT Node-Z may send a response to DNRS to acknowledge the creation of a virtual DLT network (e.g., vDLT-1). DNRS may add vDLT-1 into the DLT network repository.

At 8, DNRS may send a response to DARS to acknowledge the creation of a new virtual DLT network (e.g., vDLT-1).

At 9, DARS may assign vDLT-1 to DDApp-X and may send a response to acknowledge the successful registration of the DDApp-X.

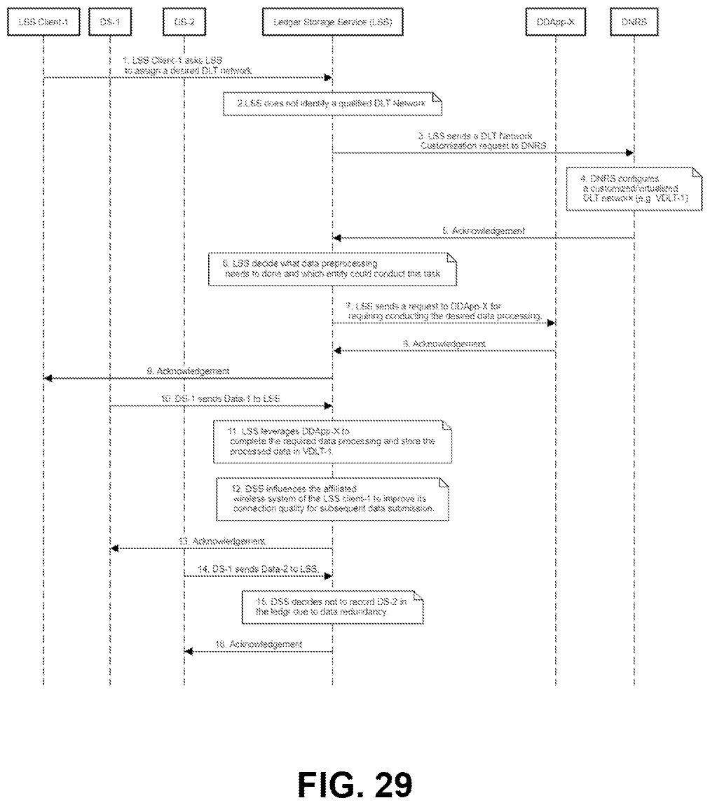

FIG. 29 shows another example PDL procedure. In an embodiment, DCE may be the Ledger Storage Service (LSS), the DTL Network Registration Service (DNRS), and may be in the PDL. The DCE client/user may be an LSS client and/or a distributed data application in PDL. The Crowdsourcing-based Information Processor (CIP) may be embodied as a distributed application (e.g., a DDApp-X) in PDL and/or a platform service in the PDL system in PDL or DCE itself. A Data Provider (DP) may be embodied as a Data Source (DS) in ETSI PDL.

In an embodiment, LSS may provide various optimizations for the data submission process (e.g., when data may be submitted from LSS clients to the desired underlying DLT network), and there may be a number of functions that may be included. In an example, an LSS may realize one or more of the following paragraphs.

In an example, based on the request and/or parameters (e.g., the needs) of LSS clients, the LSS may decide whether a customized DLT network may be used. If so, the LSS may contact DNRS to configure a customized DLT network meeting the requests and/or parameters of the LSS clients. The LSS may decide whether different types of data submitted by the LSS clients may be stored in the same ledger or different ledgers.

In an example, different LSS clients may submit their ledger transactions, which may include duplicated/redundant application data for serving the same purpose. The LSS may be configured to reduce data redundancy, for example, to avoid storing redundant ledger transactions in the underlying DLT networks.

In an example, an LSS client may have the ability to submit raw/original data to an LSS. An LSS may have the capability to conduct data preprocessing (e.g., data transformation, data filtering, data tailoring, data aggregation, data analysis, etc.) and store the processed data onto DLT networks.

In an example, when a LSS client (e.g., a cellphone) submits application data (e.g., important application data) to a DLT node, it may experience poor communication/network connection (e.g., due to insufficient wireless resources allocated by a serving wireless base station). It may be possible that the LSS may have the capability to interact with the affiliated wireless system of the LSS client (e.g., the LSS may be implemented as a network function inside the wireless system, or the LSS may influence the wireless system via network capability exposure service to temporarily upgrade the LSS client to a VIP user (e.g., even if this LSS client may not have been a high-priority wireless subscriber). The LSS client may have a better network connection for data submission to the DLT node.

FIG. 29 may illustrate a procedure (e.g., for one or more functions of an LSS) for how different DDM services may work together to help a DDApp-X in recording data in a DLT network. In an example, a physical DLT Network-X may have been registered to DNRS. The DLT Network-1 may have indicated to DNRS that it may support DLT virtualization technology. A DDApp-X may have already registered to DARS. An LSS Client-1 may be an entity (e.g., another DDApp) that has requests and/or parameters (e.g., requirements) to collect data from different data sources (DSs) and record them in the desired DLT network.

At 1, LSS Client-1 may ask LSS to assign a desired DLT network for recording the data generated by multiple DSs (e.g., DS-1, DS-2, etc.).

At 2, LSS may not identify a qualified DLT Network in the DLT network repository maintained by DNRS.

At 3, LSS may send a DLT Network Customization request to DNRS, along with the DLT requests and/or parameters (e.g., needs/requirements), for LSS Client-1.

At 4, DNRS may leverage DLT Network-X to configure a customized/virtualized DLT network (e.g., VDLT-1) for the LSS client-1. This may be similar to 4-7 in FIG. 28.

Referring again to FIG. 29, at 5, the DNRS may acknowledge LSS about the available VDLT-1.

At 6, the data (e.g., data (e.g., raw data) generated by DS-1 may be pre-processed before it may be recorded in the VDLT-1. As such, LSS may decide whether itself or other PDL platform services may conduct the pre-processing. In an example, (e.g., as shown in FIG. 28), a crowdsource-based approach may be adopted. For example, LSS may also check if any DDApp registered to DARS has the capability. For example, it may be assumed that when DDApp-X registered to DARS, it indicated its own requests and/or parameters (e.g., requirements and/or needs) for using DLT and indicated what kinds of capabilities (e.g., various data processing capabilities, etc.) or resources (e.g., computing) it may contribute.

At 7, LSS may send a request to DDApp-X for conducting the desired data processing. Other PDL mechanisms/services may be requested (e.g., needed) to incentivize the participating entity (DDApp-X), such as using smart contract, etc.

At 8, DDApp-X acknowledges an LSS that may be willing to help.

At 9, LSS may acknowledge the LSS Client-1 that the desired DLT network was set up successfully. The LSS Client-1 may also inform the involved DSs (e.g., DS-1, DS-2, etc.) where to submit the data (e.g., the data to be submitted to an LSS service endpoint).

At 10, DS-1 (e.g., a cellphone and/or WTRU) may send Data-1 (which may be important data) to the LSS. DS-1 may also indicate that it may be experiencing poor wireless connection, along with its service subscription details registered in the wireless system.

At 12, it may be assumed that DSS may have the capability to interact with the affiliated wireless system of the LSS client-1. The LSS may influence the wireless system to temporarily upgrade the LSS client-1 to a VIP user so that it may have a better network connection when submitting subsequent data.

At 11, LSS may leverage DDApp-X to conduct the requested data processing on Data-1 and to a (e.g., only) store the processed data in the VDLT-1.

At 13, LSS may acknowledge that Data-1 has been recorded.

At 14, another DS-1 may send Data-2 to LSS.

At 15, LSS may determine that Data-2 may be redundant since Data-1 and Data-2 have the similar/duplicated usefulness. LSS may not record Data-2 onto the ledger.

At 16, LSS acknowledges Data-2 may not have been recorded, along with an explanation.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A network entity, the network entity comprising:
a processor configured to:
receive a data collection request from an application;
send a request to a blockchain node based on the data collection request, wherein the request indicates a request to set up a customized data blockchain based on at least one parameter associated with the data collection request;
receive a first message indicating the customized data blockchain is configured; and
send a second message to the application indicating that the data collection request has been processed.

22. The network entity of claim 21, wherein the processor is further configured to:
send, to a second network entity, a data provider identification request based on the data collection request; and
receive a response message from the second network entity, wherein the response message indicates an identified data provider.

23. The network entity of claim 22, wherein the processor is further configured to:
send a third message to the identified data provider indicating data submission information associated with the customized data blockchain.

24. The network entity of claim 21, wherein the data collection request indicates one or more data collection parameters associated with the application, and wherein the request to the blockchain node comprises the one or more data collection parameters associated with the application.

25. The network entity of claim 24, wherein the customized data blockchain is configured based on the one or more data collection parameters associated with the application.

26. The network entity of claim 24, wherein the one or more data collection parameters indicates at least one of a type of data, a data provider, a geographical area, a type of data collection, or a sampling rate.

27. The network entity of claim 21, wherein the second message further indicates customized data blockchain information associated with the set up customized data blockchain.

28. The network entity of claim 21, wherein the customized data blockchain is a virtual blockchain network.

29. The network entity of claim 21, wherein the request further indicates the request to set up a customized data blockchain if no existing data blockchain can serve the data collection request.

30. A method comprising:
receiving a data collection request from an application;
sending a request to a blockchain node based on the data collection request, wherein the request indicates a request to set up a customized data blockchain based on at least one parameter associated with the data collection request;
receiving a first message indicating the customized data blockchain is configured; and
sending a second message to the application indicating that the data collection request has been processed.

31. The method of claim 30, wherein the method further comprises:
sending, to a second network entity, a data provider identification request based on the data collection request;
receiving a response message from the second network entity, wherein the response message indicates an identified data provider; and
sending a third message to the identified data provider indicating data submission information associated with the customized data blockchain.

32. The method of claim 30, wherein the data collection request indicates one or more data collection parameters associated with the application, and wherein the request to the blockchain node comprises the one or more data collection parameters associated with the application, wherein the customized data blockchain is configured based on the one or more data collection parameters associated with the application, and wherein the one or more data collection parameters indicates at least one of a type of data, a data provider, a geographical area, a type of data collection, or a sampling rate.

33. The method of claim 30, wherein the second message further indicates customized data blockchain information associated with the set up customized data blockchain.

34. The method of claim 30, wherein the customized data blockchain is a virtual blockchain network.

35. The method of claim 30, wherein the request further indicates the request to set up a customized data blockchain if no existing data blockchain can serve the data collection request.

36. A first network entity, the network entity comprising:
a processor configured to:
receive a request to set up a customized data blockchain from a second network entity, wherein the request indicates a parameter associated with data collection;
identify at least a first blockchain node (BCN) and a second BCN based on the parameter associated with data collection;
generate a customized blockchain based on the first BCN and the second BCN; and
send a second message to the second network entity indicating that the customized data blockchain is set up.

37. The first network entity of claim 36, wherein the customized data blockchain comprises an application data blockchain and a control data blockchain.

38. The first network entity of claim 37, wherein the processor is further configured to:
determine operation instructions for the application data blockchain, wherein the operation instructions are recorded in the control data blockchain.

39. The first network entity of claim 36, wherein the request indicates a data provider, and wherein the at least the first BCN and the second BCN is identified based on the indicated data provider.

40. The first network entity of claim 36, wherein the processor is further configured to:
obtain a list of BCNs, wherein the list of BCNs comprises at least the first BCN and the second BCN.
